(19) United States
(12) Patent Application Publication
(10) Pub. No.: US 2008/0291223 A1
(43) Pub. Date: Nov. 27, 2008

(54) ELECTRO-OPTICAL DEVICE, DRIVING CIRCUIT OF ELECTRO-OPTICAL DEVICE, AND ELECTRONIC APPARATUS

(75) Inventors: Katsunori YAMAZAKI, Matsumoto-shi (JP); Koji SHIMIZU, Matsumoto-shi (JP)

Correspondence Address: OLIFF & BERRIDGE, PLC, P.O. BOX 320850, ALEXANDRIA, VA, 22320-4850, US

(73) Assignee: EPSON IMAGING DEVICES CORPORATION, Azumino-shi (JP)

(21) Appl. No.: 12/103,380

(22) Filed: Apr. 15, 2008

(30) Foreign Application Priority Data
May 21, 2007 (JP) 2007-133792
May 21, 2007 (JP) 2007-134034

(51) Int. Cl. G09G 5/10

(52) U.S. Cl. 345/690

(57) ABSTRACT

A driving circuit of an electro-optical device includes scanning lines, data lines, capacitor lines respectively corresponding to the scanning lines, and pixels provided at intersections of the scanning lines and the data lines. The driving circuit includes a scanning line driving circuit that selects the scanning lines in a predetermined order and a capacitor line driving circuit that selects a first power supply line when a first scanning line is selected and selects a second power supply line when a second scanning line that is spaced predetermined lines away from the first scanning line is selected until the first scanning line is selected again to thereby apply a voltage of the selected one of the power supply lines to the capacitor line, the capacitor line driving circuit applying the voltage of the second power supply line to all the capacitor lines when all the scanning lines are not selected.

### BACKGROUND

1. Technical Field

The present invention relates to an electro-optical device that uses an electrooptic material, such as a liquid crystal, for example, a driving circuit of the electro-optical device and an electronic apparatus that includes the electro-optical device and, more particularly, to a technology that suppresses the voltage amplitude in a data line with a simple structure and that also suppresses a decrease in display quality.

2. Related Art

An electro-optical device, such as a liquid crystal device, includes pixel capacitors (liquid crystal capacitors) that are provided at positions corresponding to intersections of scanning lines and data lines. When the pixel capacitors need to be driven with alternating current, the voltage amplitude of data signals takes both positive polarity and negative polarity. Thus, a data line driving circuit that supplies data signals to the data lines is required to have a withstand voltage against the voltage amplitude of components. Therefore, there has been proposed a technology that suppresses the voltage amplitude of data signals in such a manner that the storage capacitors are provided in parallel with the pixel capacitors and, in each row, a capacitor line to which the storage capacitors are commonly connected are driven in binary in synchronization with selection of a corresponding one of the scanning lines, which is described in JP-A-2001-83943. In addition, there has been known a method of driving an existing display device in which, in a period during which a pixel switching element is in an off state and until the time when the pixel switching element enters an on state next, a first line connected to the pixel electrode is applied with a modulation signal of which a voltage changes inversely once in every vertical scanning period, so that the electric potential of the pixel electrode is varied and then a variation in the electric potential and an image signal voltage are superposed and/or cancelled with each other to thereby apply a voltage to a display material, which is, for example, described in the specification of Japanese Patent No. 2,568,659. in this manner, it is possible to reduce power consumption of the driving circuit by reducing the voltage amplitude of the data lines.

In the above technology, because a circuit that drives the capacitor lines is equivalent to a scanning line driving circuit (actually, a shift register) that drives the scanning lines, it has been suggested that there is a problem that a circuitry for driving the capacitor lines becomes complex. In addition, in the existing device described in the specification of Japanese Patent No. 2,568,659, a specific configuration of a circuit that individually drives the capacitor lines is not disclosed. For example, when this circuit is configured to perform a control using a signal that is generated externally, it is not possible to achieve high definition because of restrictions of packaging density and also the cost runs up because the number of leads increases and, as a result, the width of a so-called window frame outside the display area increases. In order to avoid the above situation, it has been disclosed that the storage capacitor is formed on a gate line and a gate voltage is switched among three values or more. In this case, it requires a switching circuit of at least ternary switching for each gate line, so that a circuit that generates the waveform of a gate voltage becomes complicated.

### SUMMARY

An advantage of some aspects of the invention is that it provides an electro-optical device that is capable of suppressing the voltage amplitude of the data lines with a relatively simple circuitry, a driving circuit of the electro-optical device and an electronic apparatus.

A first aspect of the invention provides a driving circuit of an electro-optical device. The electro-optical device includes a plurality of scanning lines, a plurality of data lines, a plurality of capacitor lines, and pixels. The plurality of capacitor lines are respectively provided in correspondence with the plurality of scanning lines. The pixels are provided at positions corresponding to intersections of the plurality of scanning lines and the plurality of data lines. Each of the pixels includes a pixel switching element, a pixel capacitor and a storage capacitor. The pixel switching element is connected to a corresponding one of the data lines, a corresponding one of the scanning lines and a pixel electrode, wherein, when the connected corresponding one of the scanning lines is selected, the pixel electrode enters a conductive state with the corresponding one of the data lines. The pixel capacitor is connected between the pixel electrode and a common electrode. The storage capacitor is connected between the pixel electrode and a corresponding one of the capacitor lines, provided in correspondence with the corresponding one of the scanning lines. The driving circuit includes a scanning line driving circuit, a capacitor line driving circuit, and a data line driving circuit. The scanning line driving circuit selects the scanning lines in a predetermined order. The capacitor line driving circuit, for the capacitor line provided in correspondence with one of the scanning lines, selects a first power supply line when the one of the scanning lines is selected and selects a second power supply line since a scanning line, which is spaced predetermined lines away from the one of the scanning lines and selected after the one of the scanning lines, is selected until the one of the scanning lines is selected again to thereby apply a voltage of the selected one of the power supply lines to the capacitor line, while the capacitor line driving circuit applies the voltage of the second power supply line to all the capacitor lines in a period during which all the scanning lines are not selected. The data line driving circuit supplies the pixels corresponding to the selected one of the scanning lines with data signals corresponding to gray scales of the pixels through the respective data lines.

In this manner, it is possible to reduce power consumption by suppressing the voltage amplitude of the data lines with a simple structure. In addition, because the voltage of the second power supply line is forcibly applied to all the capacitor lines in a period during which all the scanning lines are not selected, even when a refresh period is long, it is possible to hold the voltage of each capacitor line at the voltage of the second power supply line and, thereby, it is possible to improve the display quality by preventing the occurrence of poor display, such as flicker.

In addition, a second aspect of the invention may be configured so that, in the first aspect of the invention, the electro-optical device is configured to be selectable between a full-screen display mode in which a full screen is set as a display area and a partial display mode in which part of area in the full screen is set as a display area and the other area is set as a non-display area, wherein the capacitor line driving circuit, in the partial display mode, applies the voltage of the second power supply line to all the capacitor lines in a period during which all the scanning lines are not selected.

In this manner, in the partial display mode in which the refresh period is long, in a period during which the scanning lines are not selected, it is possible to hold the voltage of each capacitor line at the voltage of the second power supply line and, thereby, it is possible to prevent the occurrence of poor display, such as flicker. Moreover, a third aspect of the invention may be configured so that, in the first or second aspect of the invention, the capacitor line driving circuit includes first to fifth transistors in correspondence with each of the capacitor lines, wherein the first transistor corresponding to one of the capacitor lines has a gate electrode connected to a scanning line that is spaced predetermined lines away from the scanning line corresponding to the one of the capacitor lines and a source electrode connected to an on voltage supply line that supplies an on voltage to make the fourth transistor enter an on state, wherein the second transistor has a gate electrode connected to the scanning line corresponding to the one of the capacitor lines and a source electrode connected to an off voltage supply line that supplies an off voltage to make the fourth transistor enter an off state, wherein the third transistor has a gate electrode connected to the scanning line corresponding to the one of the capacitor lines and a source electrode connected to the first power supply line, wherein the fourth transistor has a gate electrode connected commonly to both a drain electrode of the first transistor and a drain electrode of the second transistor and a source electrode connected to the second power supply line, wherein the fifth transistor has a gate electrode connected to an on/off voltage supply line that supplies an on voltage or an off voltage to make the fifth transistor itself enter an on state or an off state and a source electrode connected to the second power supply line, wherein a drain electrode of the third transistor, a drain electrode of the fourth transistor and a drain electrode of the fifth transistor are connected to the one of the capacitor lines, and wherein a voltage of the on/off voltage supply line is controlled to be applied with the on voltage in a period during which all the scanning lines are not selected.

In this manner, when the scanning line corresponding to one of the capacitor lines is selected, the third transistor is made to enter an on state and the fourth transistor is made to enter an off state to thereby be able to apply the voltage of the first power supply line to the one of the capacitor lines, and, in addition, since a scanning line, which is spaced predetermined lines away from the one of the scanning lines and is selected after the one of the scanning lines, is selected until the one of the scanning lines is selected again, the third transistor is made to enter an off state and the fourth transistor is made to enter an on state to thereby be able to apply the voltage of the second power supply line to the one of the capacitor lines. Thus, without a complex circuitry of the capacitor line driving circuit, it is possible to suppress the voltage amplitude of the data lines.

In addition, because the gate electrode of the fourth transistor is pulled up to the on voltage by the fifth transistor in a period during which all the scanning lines are not selected, even in the partial display mode in which the scanning cycle is long, it is possible to prevent the capacitor lines from entering a high impedance state. In addition, a fourth aspect of the invention may be configured so that, in any one of the first to third aspects of the invention, the voltage of the first power supply line and the voltage of the second power supply line are set so that, when a scanning liner which is spaced predetermined lines away from the scanning line corresponding to one of the capacitor lines, is selected, a voltage of the one of the capacitor lines varies.

In this manner, because the data signal supplied from the data line driving circuit may be set to a voltage that is determined by anticipating a variation in voltage of the pixel electrode corresponding to a variation in voltage of the capacitor line, it is possible to suppress the voltage amplitude of the data line. In addition, a fifth aspect of the invention may be configured so that, in the fourth aspect of the invention, the voltage of the first power supply line is alternately switched at predetermined cycles between different two voltages, wherein the voltage of the second power supply line is constant.

In this manner, in a period during which one of the scanning lines is selected, it is possible to stabilize the voltage of the capacitor line corresponding to the one of the scanning lines at the voltage of the second power supply line, so that it is possible to prevent adverse effects on the display quality due to a variation in voltage of the capacitor line. Furthermore, a sixth aspect of the invention may be configured so that, in any one of the first to fifth aspects of the invention, the driving circuit further includes a correction circuit that, when the one of the scanning lines is selected, supplies the first power supply line with a voltage signal by which a detection voltage of the capacitor line corresponding to the one of the scanning lines becomes a target voltage.

In this manner, even when the on resistance of the third transistor is increased, there is no possibility that a voltage distortion, which may be generated in the capacitor line, never occurs and, hence, the occurrence of display chrominance non-uniformity, or the like, is prevented. Thus, it is possible to improve the display quality. In addition, because the size of each of the third transistors may be reduced, it is possible to reduce the area of a so-called window-frame region located outside the display area and also possible to reduce the costs. In addition, a seventh aspect of the invention provides an electro-optical device. The electro-optical device includes a plurality of scanning lines, a plurality of data lines, a plurality of capacitor lines, pixels, a scanning line driving circuit, a capacitor line driving circuit, and a data line driving circuit. The plurality of capacitor lines are respectively provided in correspondence with the plurality of scanning lines. The pixels are provided at positions corresponding to intersections of the plurality of scanning lines and the plurality of data lines. Each of the pixels includes a pixel switching element, a pixel capacitor and a storage capacitor. The pixel switching element is connected to a corresponding one of the data lines, a corresponding one of the scanning lines and a pixel electrode, wherein, when the connected corresponding one of the scanning lines is selected, the pixel electrode enters a conductive state with the corresponding one of the data lines. The pixel capacitor is connected between the pixel electrode and a common electrode. The storage capacitor is connected between the pixel electrode and a corresponding one of the capacitor lines, provided in correspondence with the corresponding one of the scanning lines. The scanning line driving circuit selects the scanning lines in a predetermined order. The capacitor line driving circuit, for the capacitor line provided in correspondence with one of the scanning lines, selects a first power supply line when the one of the scanning lines is selected and selects a second power supply line since a scanning line, which is spaced predetermined lines away from the one of the scanning lines and selected after the one of the scanning lines, is selected until the one of the scanning lines is selected again to thereby apply a voltage of the selected one of the power supply lines to the capacitor line, while the capacitor line driving circuit applies the voltage of the second power supply line to all the capacitor lines in a period during which all the scanning lines are not selected. The data line driving circuit supplies the pixels corresponding to the selected one of the scanning lines with data signals corresponding to gray scales of the pixels through the respective data lines.

In this manner, it is possible to reduce power consumption by suppressing the voltage amplitude of the data lines with a simple structure, and it is possible to obtain the electro-optical device that can improve the display quality. Furthermore, an eighth aspect of the invention provides an electronic apparatus that is provided with the electro-optical device according to the seventh aspect of the invention. In this manner, it is possible to obtain the electronic apparatus that achieves both a decrease in power consumption and improvement in display quality.

Another aspect of the invention provides a driving circuit of an electro-optical device. The electro-optical device includes a plurality of rows of scanning lines, a plurality of columns of data lines, capacitor lines, and pixels. The capacitor lines are respectively provided in correspondence with the plurality of rows of scanning lines. The pixels are provided at positions corresponding to intersections of the plurality of rows of scanning lines and the plurality of columns of data lines. Each of the pixels includes a pixel switching element, a pixel capacitor, and a storage capacitor. One terminal of the pixel switching element is connected to a corresponding one of the data lines and, when a corresponding one of the scanning lines is selected, the pixel switching element enters a conductive state between the one terminal and the other terminal. One terminal of the pixel capacitor is connected to the other terminal of the pixel switching element, and the other terminal of the pixel capacitor is connected to a common electrode. The storage capacitor is connected between the one terminal of the pixel capacitor and the capacitor line corresponding to the corresponding one of the scanning lines. The driving circuit includes a scanning line driving circuit, a capacitor line driving circuit, and a data line driving circuit. The scanning line driving circuit selects the scanning lines in a predetermined order. The capacitor line driving circuit connects the capacitor line provided in correspondence with one of the scanning lines to a first power supply line when the one of the scanning lines is selected, and continues to connect the capacitor line to a second power supply line after the selection is completed. The data line driving circuit supplies the pixels corresponding to the selected one of the scanning lines with data signals corresponding to gray scales of the pixels through the respective data lines. A voltage of the first power supply line, when the one of the scanning lines is selected, is set to be different from a voltage of the second power supply line. According to the above aspect of the invention, it is only necessary that the capacitor line is connected to the first power supply line when the corresponding one of the scanning lines is selected and, after the selection is completed, connected to the second power supply line. Thus, it is possible to simplify the configuration while suppressing a variation in electric potential of the capacitor line.

In the aspect of the invention, the voltage of the first power supply line may be alternately switched at predetermined intervals between two different voltages, and the voltage of the second power supply line may be constant or the voltage of the second power supply line may be set to an intermediate value between the two voltages of the first power supply line. At this time, it is desirable that the voltage of the first power supply line is switched every time one scanning line is selected. In addition, the aspect of the invention may be configured so that the capacitor line driving circuit includes a first transistor, a second transistor, a third transistor and a fourth transistor in correspondence with each of the plurality of rows of capacitor lines, wherein the first transistor corresponding to one of the capacitor lines has a gate electrode connected to a gate control line and a source electrode connected to an on voltage supply line that supplies an on voltage to make the fourth transistor enter an on state, wherein the second transistor has a gate electrode connected to the scanning line corresponding to the one of the capacitor lines and a source electrode connected to an off voltage supply line that supplies an off voltage to make the fourth transistor enter an off state, wherein the third transistor has a gate electrode connected to the scanning line corresponding to the one of the capacitor lines and a source electrode connected to the first power supply line, wherein the fourth transistor has a gate electrode connected commonly to both a drain electrode of the first transistor and a drain electrode of the second transistor and a source electrode connected to the second power supply line, and wherein a drain electrode of the third transistor and a drain electrode of the fourth transistor are connected to the one of the capacitor lines In this configuration, the on voltage is held in the gate electrode of the fourth transistor by the gate control signal in a period other than the period during which the corresponding one of the scanning lines is selected, so that the on state of the fourth transistor may be continued. In this configuration, it may be configured so that the driving circuit includes a plurality of sets of the first transistor, the second transistor and the fourth transistor in correspondence with one of the capacitor lines, wherein the fourth transistor that connects the one of the capacitor lines to the second power supply line is switched among the plurality of sets in a predetermined order. When the fourth transistor is switched as described above, it is possible to reduce the influence due to degradation of the characteristic of the fourth transistor. In addition, the aspect of the invention may be configured so that the capacitor line driving circuit further includes a fifth transistor in correspondence with each of the plurality of rows of capacitor lines, wherein the fifth transistor corresponding to one of the capacitor lines has a gate electrode connected to a scanning line that is selected next with respect to the scanning line corresponding to the one of the capacitor lines, a source electrode connected to the on voltage supply line and a drain electrode connected to both a drain electrode of the first transistor and a drain electrode of the second transistor. Furthermore, the aspect of the invention may be configured so that the driving circuit further includes an operational amplifier and a sixth transistor that is provided in correspondence with each of the plurality of rows of capacitor lines, wherein the sixth transistor corresponding to one of the capacitor lines has a gate electrode connected to the scanning line corresponding to the one of the capacitor lines, a source electrode connected to the one of the capacitor lines and a drain electrode connected to a detection line, wherein the operational amplifier controls the voltage of the first power supply line so that a voltage of the detection line, when the one of the scanning lines is selected, becomes a target voltage. In this manner, because the size of the third transistor may be small, it is possible to simplify the configuration, and the display quality need not be decreased even when the on resistance is not uniform among the third transistors of the lines. Note that the aspects of the invention are not limited to the driving circuit of the electro-optical device, but they may be applied to the electro-optical device, and, moreover, an electronic apparatus that is provided with the electro-optical device.

### BRIEF DESCRIPTION OF THE DRAWINGS

The invention will be described with reference to the accompanying drawings, wherein like numbers reference like elements.

FIG. 1 is a block diagram that shows the configuration of an electro-optical device according to a first embodiment.

FIG. 2 is a view that shows a display area in a partial display mode.

FIG. 3 is a view that shows the configuration of pixels.

FIG. 4 is a view that shows the configuration around the boundary between the display area and a capacitor line driving circuit according to the first embodiment.

FIG. 5 is a view that illustrates the operation of a full-screen display mode according to the first embodiment.

FIG. 6A and FIG. 6B are views, each of which shows the relationship between a data signal and a holding voltage according to the first embodiment.

FIG. 7 is a view that illustrates the operation in the partial display mode according to the first embodiment.

FIG. 8 is a block diagram that shows the configuration of an electro-optical device according to a second embodiment.

FIG. 9 is a view that shows the configuration of a first capacitive signal output circuit.

FIG. 10 is a view that shows the configuration of an electro-optical device according to a third embodiment of the invention.

FIG. 11 is a view that shows the configuration of pixels in the electro-optical device.

FIG. 12 is a view that shows the configuration around the boundary between the display area and the capacitor line driving circuit in the electro-optical device.

FIG. 13 is a view that illustrates the operation of the electro-optical device.

FIG. 14A and FIG. 14B are views, each of which shows negative polarity writing of the electro-optical device.

FIG. 15 is a voltage waveform diagram that illustrates the operation of the electro-optical device.

FIG. 16A and FIG. 16B are views, each of which shows the relationship between a data signal and a holding voltage in the electro-optical device.

FIG. 17 is a view that shows stabilization of a capacitor line voltage in the electro-optical device.

FIG. 18 is a view that illustrates a first alternative configuration of the electro-optical device.

FIG. 19 is a view that illustrates a second alternative configuration of the electro-optical device.

FIG. 20 is a view that illustrates a third alternative configuration of the electro-optical device.

FIG. 21 is a voltage waveform diagram that illustrates the third alternative configuration.

FIG. 22A and FIG. 22B are views, each of which shows the relationship between a data signal and a holding voltage in the third alternative configuration.

FIG. 23 is a view that illustrates a fourth alternative configuration of the electro-optical device.

FIG. 24 is a view that illustrates the operation of the fourth alternative configuration.

FIG. 25 is a view that shows the configuration of an electro-optical device according to a fourth embodiment of the invention.

FIG. 26 is a view that shows the configuration around the boundary between the display area and the capacitor line driving circuit in the electro-optical device.

FIG. 27 is a view that illustrates the operation of the electro-optical device.

FIG. 28 is a view that shows the configuration of an electro-optical device according to a fifth embodiment of the invention.

FIG. 29 is a view that shows the configuration around the boundary between the display area and the capacitor line driving circuit in the electro-optical device.

FIG. 30 is a view that shows an equivalent circuit around the capacitor line driving circuit in the electro-optical device.

FIG. 31 is a view that shows the configuration of a cellular phone that uses the electro-optical device according to the embodiments.

### DESCRIPTION OF EXEMPLARY EMBODIMENTS

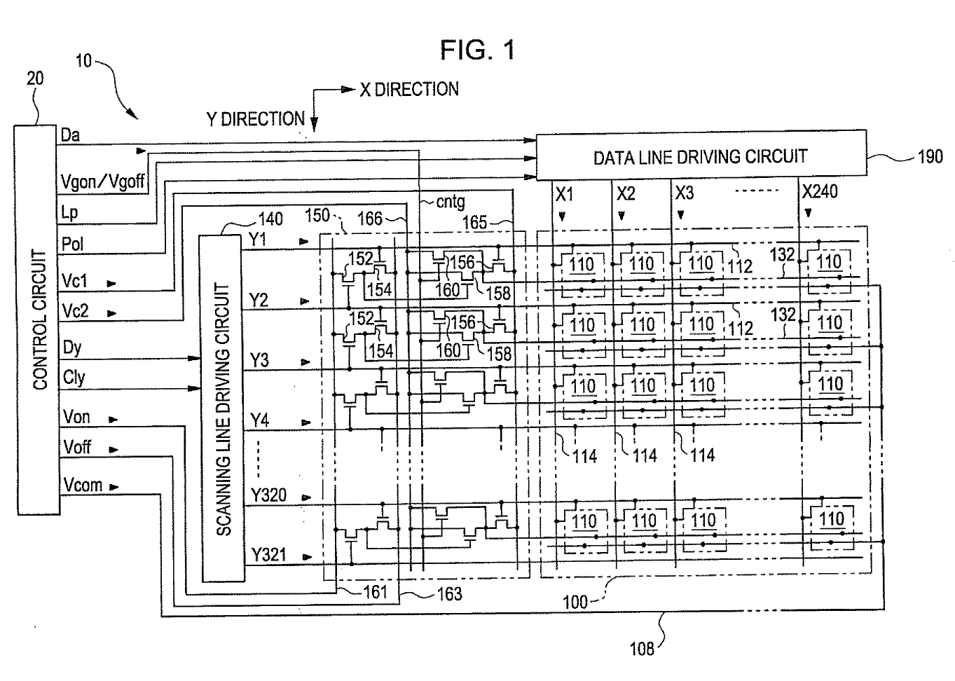

Embodiments of the invention will now be described with reference to the accompanying drawings. FIG. 1 is a block diagram that shows the configuration of an electro-optical device 10 according to a first embodiment. As shown in the drawing, the electro-optical device 10 has a display area 100 and arranges a control circuit 20, a scanning line driving circuit 140, a capacitor line driving circuit 150 and a data line driving circuit 190 around the display area 100. The display area 100 is an area in which pixels 110 are arranged. In the present embodiment, 321 scanning lines 112 are provided to extend in a row direction (X) direction, while 240 data lines 114 are provided to extend in a column (Y) direction. Then, the pixels 110 are arranged at positions corresponding to intersections of the first to 320th scanning lines 112, except the 321st scanning line 112, and the first to 240th data lines 114.

Thus, in the present embodiment, the 321st scanning line 112 does not contribute to vertical scanning (the operation to sequentially select the scanning lines in order to write a voltage to each of the pixels 110) of the display area 100. Note that, in the present embodiment, the pixels 110 are arranged in the display area 100 in a matrix of 320 rows by 240 columns; however, the aspects of the invention are not intended to be limited to this arrangement.

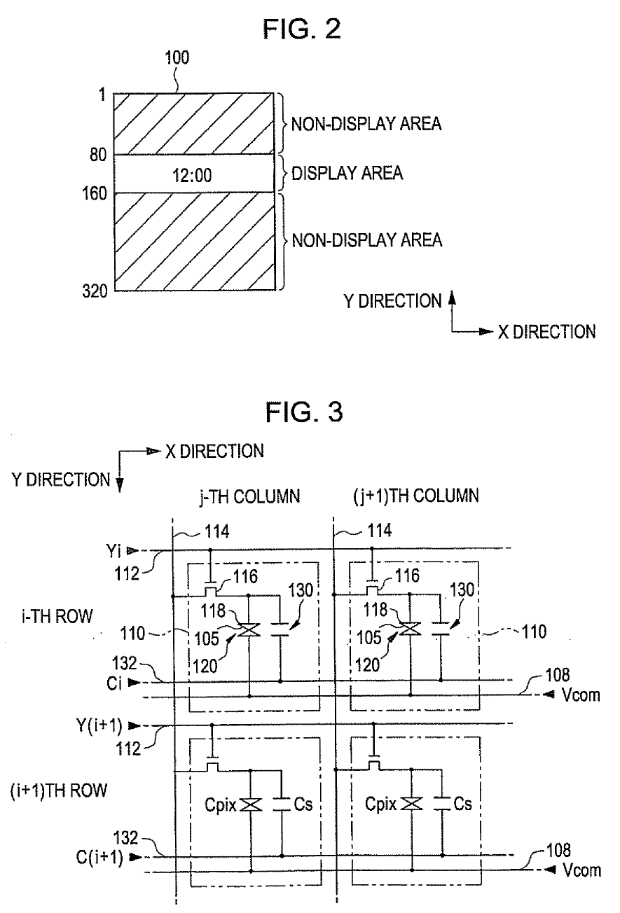

In addition, capacitor lines 132 are provided to extend in the X direction in correspondence with the first to 320th scanning lines 112. Thus, in the present embodiment, in regard to the capacitor lines 132, the first to 320th capacitor lines 132 are provided except the 321st scanning line 112, which serves as a dummy. In addition, the electro-optical device 10 according to the present embodiment is selectable between a full-screen display mode, in which the full-screen of the display area 100 is set as a display area, and a partial display mode, in which part of area in the full-screen is set as a display area and the other area is set as a non-display area. In the partial display mode, for example, as shown in FIG. 2, only the area of the pixels from 80th to 160th lines from the upper end in the vertical direction (y direction), which serves as a display area, displays an image (time, the residual quantity of a battery, or the like) and the other area, which serves as a non-display area, does not display an image. That is, the non-display area appears white in the case of a normally white mode or appears black in the case of a normally black mode.

Next, the detailed configuration of the pixels 110 will be described. FIG. 3 is a view that shows the configuration of the pixels 110, showing the configuration of two by two pixels, that is, four pixels in total, corresponding to intersections of the i-th row and the (i+1)th row located adjacent to the i-th row, the j-th column and the (j+1)th column located adjacent to the j-th column. Here, i is a symbol that generally indicates a row in which the pixels 110 are arranged and, in the present embodiment, is an integer that ranges from 1 to 320. In addition, j and (j+1) are symbols that generally indicate a column in which the pixels 110 are arranged and are integers, each of which ranges from 1 to 240. Here, in regard to (i+1), when it generally indicates a row in which the pixels 110 are arranged, it is an integer that ranges from 1 to 320; however, when the scanning lines 112 are described, it will be an integer that ranges from 1 to 321 because it is necessary to include the 321 scanning line, which serves as a dummy.

As shown in FIG. 3, each of the pixels 110 includes an n-channel thin-film transistor (hereinafter, referred to as TFT) 116 that functions as a pixel switching element, a pixel capacitor (liquid crystal capacitor) 120 and a storage capacitor 130. Here, because each of the pixels 110 has the same configuration, the description will be made representatively using the pixel 110 located at the i-th row and j-th column. In the i-th row and j-th column pixel 110, the gate electrode of the TFT 116 is connected to the i-th scanning line 112, while the source electrode thereof is connected to the j-th column data line 114 and the drain electrode thereof is connected to a pixel electrode 118, which is one terminal of the pixel capacitor 120.

In addition, the other terminal of the pixel capacitor 120 is connected to a common electrode 108. The common electrode 108, as shown in FIG. 1, is common to all the pixels 110 and is supplied with a common signal Vcom. Note that, in the present embodiment, the common signal Vcom is constant at a voltage LCcom in terms of time, as will be described later. Note that, in FIG. 3, Yi and Y(i+1) respectively represent scanning signals supplied to the i-th and (i+1)th scanning lines 112, and Ci and C(i+1) respectively represent voltages of the i-th and (i+1)th capacitor lines 132.

The display area 100 includes a pair of element substrate, on which the pixel electrodes 118 are formed, and opposite substrate, on which the common electrode 108 is formed. The element substrate and the opposite substrate are spaced at a certain gap in between, and adhered so that electrode forming faces of both substrates are opposite each other. Then, a liquid crystal 105 is sealed in the gap. Therefore, each of the pixel capacitors 120 is formed to hold the liquid crystal 105, which is a kind of dielectric, with the pixel electrode 118 and the common electrode 108, and is configured to hold a voltage difference between the pixel electrode 118 and the common electrode 108. In the above configuration, the amount of transmitted light of each pixel capacitor 120 varies in accordance with the effective value of the holding voltage.

Note that the present embodiment employs a normally white mode, for easier description, in which the transmittance ratio of light becomes maximum to perform white display when the effective value of a voltage held in the pixel capacitor 120 is close to zero, while the amount of light transmitted reduces as the effective value of a voltage increases and, finally, the transmittance ratio becomes minimum to perform black display. In addition, one terminal of the storage capacitor 130 in the i-th row and j-th column pixel 110 is connected to the pixel electrode 118 (drain electrode of the TFT 116), and the other terminal is connected to the i-th capacitor line 132. Here, the capacitance of the pixel capacitor 120 and the capacitance of the storage capacitor 130 are denoted as Cpix and Cs, respectively.

Referring back to FIG. 1, the control circuit 20 outputs various control signals to perform control, or the like, on various portions of the electro-optical device 10, and supplies a first capacitive signal Vc1 to a first power supply line 165 and a second capacitive signal Vc2 to a second power supply line 166. In addition, the control circuit 20 supplies an on voltage Von, which will be described later, to an on voltage supply line 161 and supplies an off voltage Voff to an off voltage supply line 163, and, in addition, supplies a common signal Vcom to the common electrode 108. Furthermore, the control circuit 20 switches an on voltage Vgon and an off voltage Vgoff, which will be described later, at predetermined timing and then supplies it to a voltage control line cntg.

As described above, peripheral circuits, such as the scanning line driving circuit 140, the capacitor line driving circuit 150, and the data line driving circuit 190, are provided around the display area 100. The scanning line driving circuit 140, in accordance with the control of the control circuit 20, supplies scanning signals Y1, Y2, Y3, . . . , Y320 and Y321 to the first, second, third, . . . , 320th, and 321st scanning lines 112, respectively, over a period of one frame. That is, the scanning line driving circuit 140 selects the scanning lines in the order of the first, second, third, . . . , 320th, and 321st lines. The scanning line driving circuit 140 makes the scanning signal, which will be supplied to the selected scanning line, attain an H level corresponding to a selection voltage Vdd and makes the scanning signals, which will be supplied to the other scanning lines, attain an L level corresponding to a non-selection voltage (ground electric potential Gnd).

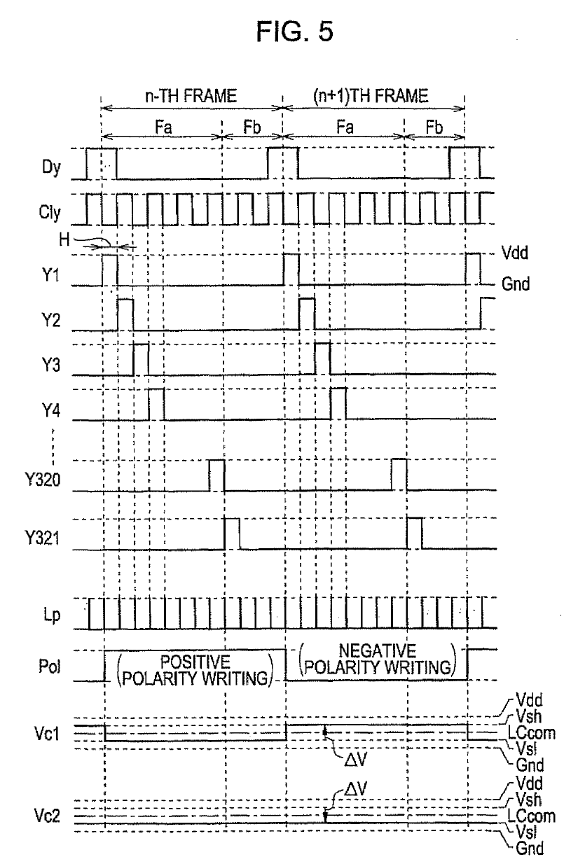

Note that, more specifically, the scanning line driving circuit 140, as shown in FIG. 5, sequentially shifts a start pulse Dy, which is supplied from the control circuit 20, in accordance with a clock signal Cly, or the like, to thereby output scanning signals Y1, Y2, Y3, Y4, . . . , Y320 and Y321. In addition, in the present embodiment, the period of one frame, as shown in FIG. 5, includes an effective scanning period Fa from time when the scanning signal Y1 attains an H level to time when the scanning signal Y320 attains an L level and a retrace period Fb from time when the dummy scanning signal Y321 attains an H level to time when the scanning signal YI attains an H level again. In addition, a period during which one scanning line 112 is being selected is a horizontal scanning period (H).

In the present embodiment, the capacitor line driving circuit 150 is formed of a set of TFTs 152, 154, 156, 158 and 160 that are provided in correspondence with each of the first to 320th capacitor lines 132. Here, when the set of TFTs 152, 154, 156, 158 and 160 corresponding to the i-th capacitor line 132 is described, the gate electrode of the TFT 152 (first transistor) is connected to the (i+1)th scanning line 112 that will be selected next after the i-th scanning line 112, and the source electrode of the TFT 152 is connected to the on voltage supply line 161. The gate electrode of the i-th TFT 154 (second transistor) is connected to the i-th scanning line 112, and the source electrode thereof is connected to the off voltage supply line 163. At the same time, the drain electrodes of the i-th TFTs 152 and 154 both are connected to the gate electrode of the i-th TFT 158 (fourth transistor).

On the other hand, the gate electrode of the i-th TFT 156 (third transistor) is connected to the i-th scanning line 112, and the source electrode thereof is connected to the first power supply line 165. The source electrode of the i-th TFT 158 is connected to the second power supply line 166. In addition, the gate electrode of the i-th TFT 160 (fifth transistor) is connected to the voltage control line cntg (on/off voltage supply line), and the source electrode thereof is connected to the second power supply line 166.

Then, the drain electrodes of the TFTs 156, 158 and 160 all are connected to the i-th capacitor line 132. Here, the on voltage Von, which is supplied to the on voltage supply line 161, is a voltage that makes the TFT 158 enter an on state (a conductive state between the source and drain electrodes) when it is applied to the gate electrode of the TFT 158. The on voltage Von is, for example, a voltage Vdd. In addition, the off voltage Voff, which is supplied to the off voltage supply line 163, is a voltage that makes the TFT 158 enter an off state (a non-conductive state between the source and drain electrodes) when it is applied to the gate electrode of the TFT 158. The off voltage is, for example, a zero voltage (ground electric potential Gnd).

Furthermore, the voltage control line cntg is supplied with the on voltage Vgon or the off voltage Vgoff from the control circuit 20. In the present embodiment, the control circuit 20 is configured, in the partial display mode, to supply the on voltage Vgon to the voltage control line cntg in a period during which all the scanning lines 112 are not selected or supply the off voltage Vgoff in the other period. Here, the on voltage Vgon is a voltage that makes the TFT 160 enter an on state when it is applied to the gate electrode of the TFT 160. The on voltage is, for example, a voltage Vdd. In addition, the off voltage Vgoff is a voltage that makes the TFT 160 enter an off state when it is applied to the gate electrode of the TFT 160. The off voltage Vgoff is, for example, a zero voltage (ground electric potential Gnd).

In addition, the size of each of the TFTs 152, 154, 156, 158 and 160 may be changed appropriately and is, for example, set so that TFT 156≧TFT 158≧TFT 152, 154 or 160. The data line driving circuit 190 supplies the first, second, third, . . . , and 240th data lines 114 with voltages that correspond to gray scales of the pixels 110 located on the scanning line 112 that is selected by the scanning line driving circuit 140 and that are data signals X1, X2, X3, . . . , and X240 of voltages with polarity that is specified by a polarity specifying signal Pol.

Here, the data line driving circuit 190 has storage areas (not shown) corresponding to matrix arrangement of 320 rows by 240 columns. Each of the storage areas stores a display data Da that specifies a gray-scale value (brightness) of the corresponding pixel 110. The display data Da stored in each of the storage areas, when the content of display needs to be changed, are updated in such a manner that new display data Da after being changed is supplied together with the address by the control circuit 20.

The data line driving circuit 190 reads out the display data Da of the pixels 110, which are located on the selected scanning line 112, from the storage areas and converts the read display data Da into data signals of voltages that correspond to the gray-scale values and that have specified voltage polarity, and then executes the operation to supply the data signals to the first to 240th data lines 114 that are located on the selected scanning line 112. Here, the polarity specifying signal Pol is a signal that specifies positive polarity writing when it is at an H level or that specifies negative polarity writing when it is at an L level. As shown in FIG. 5, in the present embodiment, the polarity specifying signal Pol inverts its polarity once in every period of one frame. That is, in the present embodiment, polarities written to the pixels in a period of one frame are the same, and a surface inversion driving by which the writing polarity is inverted once in every period of one frame is employed. The reason why the polarity is inverted as described above is to prevent degradation of the liquid crystal due to an applied direct-current component.

In addition, in regard to the writing polarity in the present embodiment, in the case where a voltage corresponding to a gray scale is held in the pixel capacitor 120, the polarity is positive when the voltage of the pixel electrode 118 is higher than the voltage LCcom of the common electrode 108, while the polarity is negative when the voltage of the pixel electrode 118 is lower than the voltage LCcom. On the other hand, the voltage uses the ground electric potential Gnd of power supply as the reference, unless otherwise stated.

Note that the control circuit 20 supplies a latch pulse Lp to the data line driving circuit 190 at the timing when the logic level of the clock signal Cly changes. As described above, the scanning line driving circuit 140 outputs the scanning signals Y1, Y2, Y3, Y4, . . . , Y320 and Y321 in such a manner that the start pulse Dy is sequentially shifted, or the like, in accordance with the clock signal Cly. Thus, the start timing of a period during which the scanning line is selected is the timing at which the logic level of the clock signal Cly changes. Accordingly, the data line driving circuit 190 is able to recognize which one of scanning lines is selected by, for example, continuously counting the latch pulse Lp over a period of one frame and is also able to recognize the start timing of that selection on the basis of the timing to supply the latch pulse Lp.

Note that, in the present embodiment, on the element substrate, in addition to the scanning lines 112, the data lines 114, the TFTs 116, the pixel electrodes 118 and the storage capacitors 130 in the display area 100, the TFTs 152, 154, 156, 158 and 160, the on voltage supply line 161, the off voltage supply line 163, the first power supply line 165, the second power supply line 166, and the like, in the capacitor line driving circuit 150 are formed.

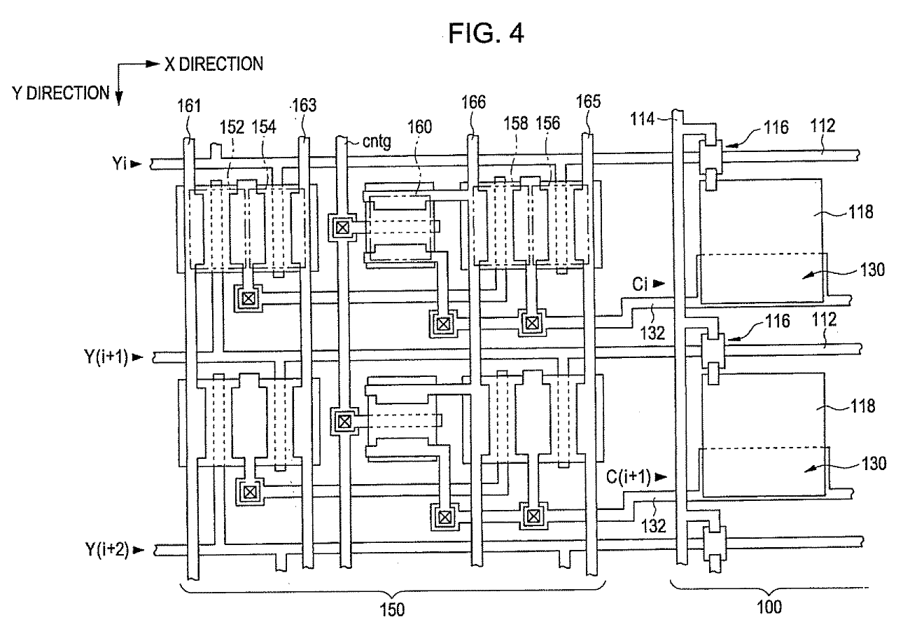

FIG. 4 is a plan view that shows the configuration around the boundary between the capacitor line driving circuit 150 and the display area 100 within the above described element substrate. As shown in the drawing, in the present embodiment, the TFTs 116, 152, 154, 156, 158 and 160 each are of an amorphous silicon type and a bottom gate type in which the gate electrode of each of them is located on the lower side than the semiconductor layer.

Specifically, the scanning lines 112, the capacitor lines 132 and the gate electrodes of the TFTs 158 are formed by patterning a gate electrode layer, which serves as a first conductive layer, and a gate insulating film (not shown) is formed thereon. Furthermore, the semiconductor layers of the TFTs 116, 152, 154, 156, 158 and 160 are formed in an island shape. On the semiconductor layer, the rectangular pixel electrodes 118 are formed by patterning an ITO (indium tin oxide) layer, which serves as a second conductive layer, through a protective layer, and, furthermore, the data lines 114, which serve as the source electrodes of the TFTs 116, the on voltage supply line 161, the off voltage supply line 163, the first power supply line 165, the second power supply line 166 and the voltage control line cntg are formed and the drain electrodes of these TFTs are formed by patterning a metal layer, such as aluminum, which serves as a third conductive layer.

Here, the gate electrodes of the TFTs 154 and 156 are portions that are branched from the scanning line 112 respectively in the Y (downward) direction in a T shape, and the gate electrode of the TFT 152 is a portion that is branched from the scanning line 112 in the Y (upward) direction in a T shape. In addition, each of the storage capacitors 130 is configured so that part of the capacitor line 132, which is formed in the lower layer relative to the pixel electrode 118 so as to have a large width, and the pixel electrode 118 hold the above gate insulating film in between as a dielectric.

In addition, the common drain electrode of the TFTs 152 and 154 and the gate electrode of the TFT 158 are electrically connected through a contact hole (the symbol × in the drawing) that extends through the gate insulating film. Similarly, the common drain electrode of the TFTs 156 and 158 and the capacitor line 132 are electrically connected through a contact hole. Furthermore, the gate electrode of the TFT 160 is electrically connected to the voltage control line cntg through a contact hole, and the drain electrode is electrically connected to the capacitor line 132 through a contact hole.

Note that the common electrode 108 that is opposed to the pixel electrodes 118 is formed on the opposite substrate, so that it is not shown in FIG. 4 that shows a plan view of the element substrate. FIG. 4 is just illustrative, and the type of a TFT may be another structure, for example, a top-gate type in terms of the arrangement of the gate electrode or a polysilicon type in terms of a process. In addition, it is applicable that the element of the capacitor line driving circuit 150 is not mounted in the display area 100 but an IC chip is mounted on the element substrate.

When the IC chip is mounted on the element substrate, the scanning line driving circuit 140 and the capacitor line driving circuit 150 may be integrally formed as a semiconductor chip together with the data line driving circuit 190 or may be separately formed. In addition, the control circuit 20 may be connected through an FPC (flexible printed circuit) substrate, or the like, or may be mounted on the element substrate as a semiconductor chip.

In addition, when the present embodiment is configured not as a transmissive type but as a reflective type, the pixel electrodes 118 may be formed by patterning a reflective conductive layer or may be formed with an additional reflective metal layer. Furthermore, a so-called transflective type in which both the transmissive type and the reflective type are combined may be employed. Next, the operation of the electro-optical device 10 according to the present embodiment will be described.

FIG. 5 is a time chart that illustrates the operation of the full-screen display mode according to the first embodiment. As described above, the present embodiment employs surface inversion driving. Thus, the control circuit 20, as shown in FIG. 5, specifies positive polarity writing by setting the polarity specifying signal Pol to an H level in a period of a certain frame (denoted as “n-th frame) and specifies negative polarity writing by setting the polarity specifying signal Pol to an L level in a period of the next (n+1)th frame to thereby invert the writing polarity once in every period of one frame thereafter in the same manner.

In addition, the control circuit 20, in the n-th frame, sets a first capacitive signal Vc1 and a second capacitive signal Vc2 to a voltage Vs1 having the same electric potential and, in the (n+1)th frame, sets the first capacitive signal Vc1 to a voltage Vsh that is increased by a voltage ΔV relative to the second capacitive signal Vc2 (voltage Vsl). Furthermore, the control circuit 20, in the full-screen display mode, sets a control signal, which is always supplied to the voltage control line cntg, to an L level to thereby supply the gate electrode of the TFT 160 with the off voltage Vgoff (Gnd).

First, the operation in the n-th frame will be described. In the n-th frame, the scanning signal Y1 is initially set to an H level by the scanning line driving circuit 140. As the latch pulse Lp is output at the timing when the scanning signal Y1 attains an H level, the data line driving circuit 190 reads out the display data Da of the first, second, third, . . . , and 240th column pixels in the first row and converts the display data Da into the data signals X1, X2, X3, . . . , and X240 of voltages that are set to the higher side with reference to the voltage LCcom by the potentials of voltages specified by the display data Da, and then supplies the data signals to the first, second, third, . . . , and 240th data lines 114, respectively.

In this manner, for example, the j-th data line 114 is applied with a positive polarity voltage that is set to the higher side with reference to the voltage LCcom by the potential of a voltage specified by the display data Da of the first row and j-th column pixel 110 as the data signal Xj. Thus, the first row and first column to the first row and 240th column pixel capacitors 120 are written with positive polarity voltages corresponding to the respective gray scales. On the other hand, when the scanning signal Y1 is at an H level, the TFTs 154 and 156 corresponding to the first capacitor line 132 enter an on state in the capacitor line driving circuit 150. At this time, because the scanning signal Y2 is at an L level, the TFT 152 is in an off state. In addition, because a control signal supplied to the voltage control line cntg is at an L level, the TFT 160 is also in an off state.

In this manner, the gate electrode of the TFT 158 is applied with the off voltage Voff and, hence, the TFT 158 enters an off state. As a result, the first capacitor line 132 is connected to the first power supply line 165 and is then applied with the voltage Vsl. Thus, the first row and first column to the first row and 240th column storage capacitors 130 are written with voltage differences between the voltage Vsl and positive polarity voltages corresponding to the respective gray scales.

Next, the scanning signal Y1 attains an L level and, at the same time, the scanning signal Y2 attains an H level. As the scanning signal Y1 attains an L level, the TFTs 116 in the first row and first column to the first row and 240th column pixels each enter an off state. In addition, in the capacitor line driving circuit 150, the TFTs 154 and 156 corresponding to the first capacitor line 132 enter an off state and the first TFT 152 enters an on state. In addition, because a control signal supplied to the voltage control line cntg maintains an L level, the TFT 160 maintains an off state.

In this manner, the gate electrode of the first TFT 158 is applied with the on voltage Von and, hence, the TFT 158 enters an on state. As a result, the first capacitor line 132 is connected to the second power supply line 166; however, in the n-th frame during which positive polarity writing is specified, the second power supply line 166 does not vary in electric potential because the second power supply line 166 is applied with the same voltage vsl as the first power supply line 165. The operation in which the first capacitor line 132 maintains the voltage Vsl continues during time when the scanning signal Y1 is at an L level, that is, until the scanning signal Y1 attains an H level again.

Then, when the polarity specifying signal Pol is at an H level and positive polarity writing is specified, even when the scanning signal Y2 attains an H level, voltages that are held respectively in the first row and first column to the first row and 240th column pixel capacitors 120 and storage capacitors 130 do not change. Thus, because the voltage Vsl is maintained in the first capacitor line 132, voltages that are held in the first row and first column to the first row and 240th column pixel capacitors 120 and storage capacitors 130 do not change until the scanning signal Y1 attains an H level again. Eventually, the first row and first column to the first row and 240th column pixel capacitors 120 continue to hold voltage differences between the voltage LCcom of the common electrode 108 and the voltages of the data signals that are applied to the pixel electrodes 118 when the scanning signal Y1 attains an H level, that is, the voltages corresponding to the respective gray scales.

On the other hand, as the latch pulse Lp is output at the timing when the scanning signal Y2 attains an H level, the data line driving circuit 190 supplies the data signals X1, X2, X3, . . . , and X240 of positive polarity voltages, corresponding to the gray scales of the first, second, third, . . . , and 240th column pixels in the second row, to the first, second, third, . . . , and 240th data lines 114, respectively. In this manner, the second row and first column to the second row and 240th column pixel capacitors 120 are written with positive polarity voltages corresponding to the respective gray scales.

Note that, when the scanning signal Y2 is at an H level, in the capacitor line driving circuit 150, the TFTs 154 and 156 corresponding to the second capacitor line 132 both enter an on state and the TFT 158 enters an off state. Thus, the second capacitor line 132 is connected to the first power supply line 165 and is then applied with the voltage Vsl, so that the second row and first column to the second row and 240th column storage capacitors 130 are written with voltage differences between the voltage Vs1 and the positive polarity voltages corresponding to the respective gray scales.

In a period of the n-th frame during which the polarity specifying signal Pol is at an H level, the same operation will be repeated until the scanning signal Y321 attains an H level. In this manner, the voltage of a data signal applied to the pixel electrode 118, that is, a voltage difference between a positive polarity voltage corresponding to a gray scale and the voltage LCcom of the common electrode 108, is held in each of the pixel capacitors 120. In addition, a voltage difference between a positive polarity voltage corresponding to a gray scale and the voltage Vsl is held in each of the storage capacitors 130.

Next, the operation in the (n+1)th frame during which the polarity specifying signal Pol is at an L level will be described. In the (n+1)th frame, the control circuit 20 is configured to set the first capacitive signal Vc1 to the voltage Vsh that is higher by ΔV than the voltage Vsl, as shown in FIG. 5. In addition, as the latch pulse Lp is output at the timing when the scanning signal Yi attains an H level, the data line driving circuit 190 outputs data signals X1, X2, X3, . . . , and X240 that correspond to the display data Da of the first, second, third, . . . , and 240th column pixels in the i-th row and that correspond to negative polarity.

Thus, a variation in voltage of the i-th row and j-th column pixel capacitor 120 in the (n+1)th frame will be as follows. First, as the scanning signal Yi attains an H level, the i-th row and j-th column TFT 116 enters an on state. Thus, the data signal Xj is applied to both one terminal (pixel electrode 118) of the pixel capacitor 120 and one terminal of the storage capacitor 130. On the other hand, when the scanning signal Yi is at an H level, in the capacitor line driving circuit 150, the TFTs 154 and 156 corresponding to the i-th capacitor line 132 enter an on state and the TFT 158 enters an off state. Thus, the voltage Ci of the i-th capacitor line 132 will be the voltage Vsh of the first power supply line 165. Note that the common electrode 108 is constant at the voltage LCcom.

Thus, where the voltage of the data signal Xj at this time is Vj, the i-th row and j-th column pixel capacitor 120 is charged with a voltage (Vj-LCcom), and the storage capacitor 130 is charged with a voltage (Vj-Vsh). Next, as the scanning signal Yi attains an L level, the i-th row and j-th column TFT 116 enters an off state. In addition, as the scanning signal Yi attains an L level, the next scanning signal Y(i+1) attains an H level. Thus, in the capacitor line driving circuit 150, the TFTs 154 and 156 corresponding to the i-th capacitor line 132 enter an off state, and the TFT 152 corresponding to the i-th capacitor line 132 enters an on state, whereby the TFT 158 enters an on state. Hence, the voltage Ci of the i-th capacitor line 132 becomes the voltage Vsl of the second power supply line 166 and, in comparison with the voltage when the scanning signal Yi is at an H level, decreases by the voltage ΔV. In contrast, the common electrode 108 is constant at the voltage LCcom. Thus, because electric charge stored in the pixel capacitor 120 moves to the storage capacitor 130, the voltage of the pixel electrode 118 decreases.

Specifically, the voltage of the pixel electrode 118 decreases by {Cs/(Cs+Cpix)}·ΔV(=ΔVpix) from the voltage Vj of the data signal when the scanning signal Yi was at an H level. However, the parasitic capacitances of various portions are ignored here. Here, the data signal Xj, when the scanning signal Yi is at an H level, is set to the voltage Vj that is determined by anticipating that the pixel electrode 118 decreases by the voltage ΔVpix. That is, the decreased voltage of the pixel electrode 118 is set lower than the voltage LCcom of the common electrode 108 and makes a voltage difference between the pixel electrode 118 and the common electrode 108 take a value corresponding to a gray scale of the i-th row and j-th column pixel.

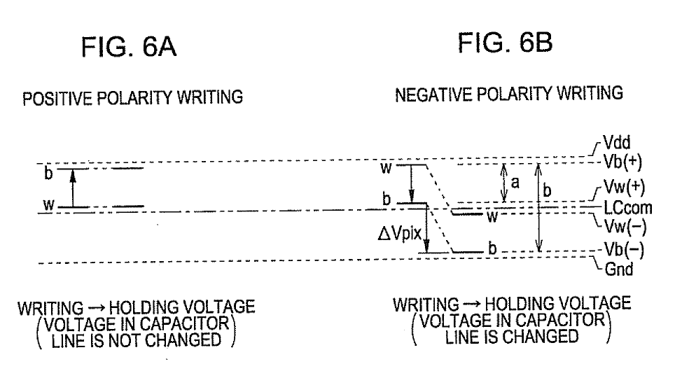

FIG. 6A and FIG. 6B are views, each of which shows the relationship between a data signal and a holding voltage. In the present embodiment, as shown in FIG. 6A and FIG. 6B, in the n-th frame during which positive polarity writing is specified, when the data signal is at a voltage that ranges from the voltage Vw(+) corresponding to white color w to the voltage Vb(+) corresponding to black color b and that becomes higher with reference to the voltage LCcom as the gray scale decreases (darkens), while, in the (n+1)th frame during which negative polarity writing is specified, the data signal is set to the voltage Vb(+) when the pixel is made to appear white color w and the data signal is set to the voltage Vw(+) when the pixel is made to appear black color b. Thus, in the (n+1)th frame, the data signal is in the same range as the voltage range of positive polarity and is inverted in the gray scale relationship.

In addition, after the voltage of the data signal is written in the (n+1)th frame, when the voltage of the pixel electrode 118 decreases by a voltage ΔVpix, the amount of decrease (Vsh−Vsl) of the voltage ΔV of the capacitor line 132 is set so that the voltage of the pixel electrode 118 ranges from the voltage Vw(−) corresponding to white color of negative polarity to the voltage Vb(−) corresponding to black color and becomes symmetrical to the voltage of positive polarity with respect to the voltage LCcom.

In this manner, in the (n+1)th frame during which negative polarity writing is specified, the voltage of the pixel electrode 118, when it has decreased by the voltage ΔVpix, is shifted to a negative polarity voltage corresponding to a gray scale, that is, a voltage that ranges from the voltage Vw(−) corresponding to white color w to the voltage Vb(−) corresponding to black color b and that becomes lower with respect to the voltage LCcom as the gray scale decreases (darkens). In this manner, in the present embodiment, the range a of a voltage applied to the data lines in the (n+1)th frame during which negative polarity writing is specified is the same as in the n-th frame during which positive polarity writing is specified; however, the voltage of the pixel electrode 118, after being shifted, becomes a negative polarity voltage corresponding to a gray scale. In this manner, according to the present embodiment, because not only the withstand voltage of the elements that constitute the data line driving circuit 190 may be narrow but also the amplitude of a voltage applied to the data lines 114 that have parasitic capacitances becomes narrow, wasteful power consumption by the parasitic capacitances does not occur.

That is, in the configuration in which the voltage of the common electrode 108 is held at the voltage LCcom and the voltage of the capacitor line 132 is held constant over each of the frames, under the condition that the pixel capacitor 120 is driven with alternating current, when a voltage that ranges from the positive polarity voltage Vw(+) to the positive polarity voltage Vb(+)is written to the pixel electrode 118 on the basis of a gray scale in a certain frame, a voltage that ranges from the negative polarity voltage Vw(−) to the negative polarity voltage Vb(−) and that is inverted with respect to the voltage LCcom should be written in the next frame if the gray scale does not change. That is, the voltage of the data signal extends over a range b shown in FIG. 6A and FIG. 6B. Therefore, not only the withstand voltage of the elements that constitute the data line driving circuit 190 needs to support the range b but also, when the voltage varies within the range b in the data line 114 that has a parasitic capacitance, there occurs an inconvenience that wasteful power is consumed owing to the parasitic capacitance. In contrast, in the present embodiment, the voltage of the data line varies within the range a and substantially decreases to half the range b, so that the above inconvenience is removed.

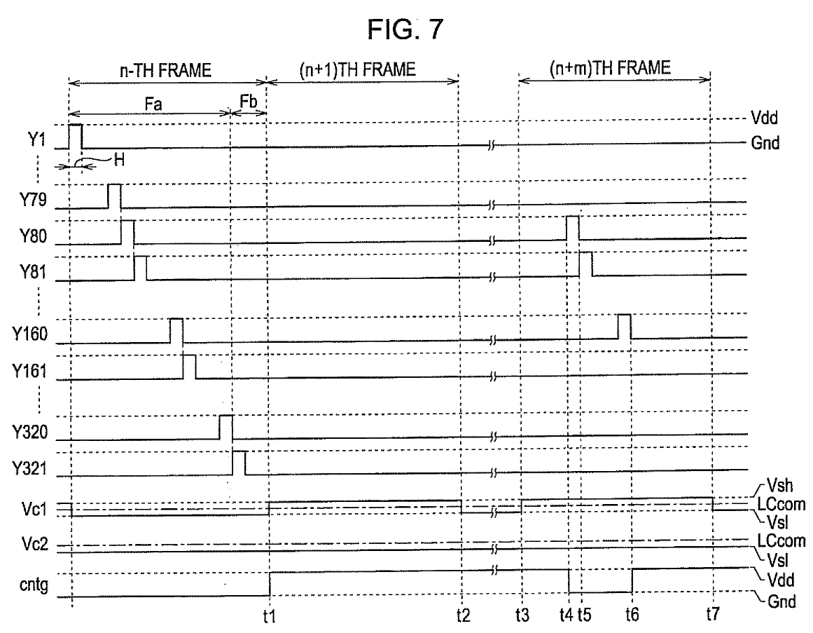

Next, the operation in the partial display mode will be described. FIG. 7 is a time chart that illustrates the operation in the partial display mode according to the first embodiment. The control circuit 20, in the partial display mode, outputs the on voltage Vgon by setting a control signal supplied to the voltage control line cntg to an H level in a period during which all the scanning lines 112 are not selected, and outputs the off voltage Vgoff by setting the control signal supplied to the voltage control line cntg to an L level during the other period.

First, the operation in the n-th frame will be described. In the n-th frame during which positive polarity writing is specified, the scanning signals Y1, Y2, . . . , and Y321 sequentially attain an H level by the scanning line driving circuit 140, and the same operation as in the n-th frame of the above described full-screen display mode is performed. However, because the first to 79th and the 161st to 320th lines are in a non-display area, the first to 79th and 161st to 320th row pixel capacitors 120 each are written with a voltage corresponding to white color, and the 80th to 160th row pixel capacitors 120, which are in a display area, are written with voltages corresponding to the respective gray scales.

In the meantime, in the full-screen display mode, the time period of one frame is, for example, 1/60 seconds, and data of each pixel are updated at a frequency of 60 Hz. On the other hand, in the partial display mode, it will be updated at a frequency of approximately 15 to 30 Hz in the display area and will be updated at a frequency of approximately 5 to 10 Hz in the non-display area. Thus, in the (n+1)th frame that comes next after the n-th frame, image data are not updated, and the scanning signal Y1 to Y321 are at an L level in a period of one frame from time t1 to time t2.

In this manner, in a period during which all the scanning lines 112 are not selected, the control signal supplied to the voltage control line cntg is at an H level and, in the capacitor line driving circuit 150, the TFTs 160 corresponding to all the capacitor lines 132 enter an on state. In addition, at this time, because the scanning signals Y1 to Y321 are at an L level, the TFTs 152, 154 and 156 corresponding to each line are in an off state. As a result, the first to 320th capacitor lines 132 are connected to the second power supply line 166 to be applied with the voltage Vsl.

The operation, in which the TFTs 160 enter an on state and the first to 320th capacitor lines 132 maintain the voltage Vsl, continues over a period during which all the scanning signals Y1 to Y321 are at an L level, that is, until image data are updated in the display area or in the non-display area again. Then, in the (n+m)th frame during which negative polarity writing is specified, image data are updated in the display area.

Because image data are not updated in the non-display area in the (n+m)th frame, the scanning signals Y1 to Y79 are at an L level in a period from time t3 to time t4 during which the first to 79th scanning lines 112 are scanned. Thus, the control signal supplied to the voltage control line cntg attains an H level and, in the capacitor line driving circuit 150, the TFTs 160 corresponding to all the capacitor lines 132 enter an on state. As a result, the first to 320th capacitor lines 132 are connected to the second power supply line 166 and maintain the voltage Vsl.

Next, in a horizontal scanning period from time t4 to time t5, as the scanning signal of the 80th scanning line 112 in the display area attains an H level, the control signal supplied to the voltage control line cntg attains an L level, so that the TFTs 160 corresponding to all the capacitor lines 132 enter an off state. On the other hand, when the scanning signal Y80 is at an H level, in the capacitor line driving circuit 150, the TFTs 154 and 156 corresponding to the 80th capacitor line 132 both enter an on state and the TFT 158 enters an off state. Thus, the 80th capacitor line 132 is connected to the first power supply line 165 and is then applied with the voltage Vsh, so that the 80th row and first column to the 80th row and 240th column storage capacitors 130 are written with voltage differences between the voltage Vsh and negative polarity voltages corresponding to the respective gray scales.

After that, the scanning signals Y81, Y82, . . . , and Y160 sequentially attain an H level, and the control signal supplied to the voltage control line cntg maintains an L level until time t6, so that the same operation will be repeated until time t6. Thus, the 81st to 160th row storage capacitors 130 are written with voltage differences between the voltage Vsh and negative polarity voltages corresponding to the respective gray scales. Then, in a period from time t6 to time t7 during which the 161st to 321st scanning lines 112 are scanned, the scanning signals Y161 to Y321 are at an L level. Thus, the control signal supplied to the voltage control line cntg attains an H level and, in the capacitor line driving circuit 150, the TFTs 160 corresponding to all the capacitor lines 132 enter an on state. As a result, the first to 320th capacitor lines 132 are connected to the second power supply line 166 and is then applied with the voltage Vsl.

In the present embodiment, even after the scanning signal Y(i+1) changes to an L level, the gate electrode of the TFT 158 corresponding to the i-th capacitor line 132 is maintained at the on voltage Von owing to its parasitic capacitance and thereby the TFT 158 continues to be in an on state. As a result, the i-th capacitor line 132 is maintained at the voltage Vs1 of the second capacitive signal Vc2. In the case of the present embodiment, the write holding period (refresh period) of the full-screen display mode is relatively short and is 1/60 seconds; however, the refresh period of the partial display mode is relatively long and is approximately 1/15 to 1/30 seconds in the display area and approximately ⅕ to 1/10 seconds in the non-display area. When the refresh period is long as described above, it is difficult for each of the TFTs 158 to maintain the on voltage because of the leakage of electric charge from the parasitic capacitance of the gate electrode and, as a result, the capacitor line 132 enters a high impedance state. At this time, as the electric potential of a scanning line varies, there is a possibility that poor display, such as column flicker, may occur. In addition, there is also a possibility that the electric potential of the capacitor line varies because of the leakage of electric current and, thereby, a burn-in, or the like, may occur.

In contrast, in the present embodiment, in a period during which all the scanning lines 112 are not selected, the capacitor lines 132 are forcibly connected to the second power supply line 166 and, thereby, the voltage of each capacitor line 132 is set to the voltage Vsl of the second capacitive signal Vc2, so that it is possible to reliably prevent the capacitor lines 132 from entering a high impedance state and also possible to prevent adverse effects on the display quality.

In this manner, in the first embodiment, the capacitor line driving circuit, for the capacitor line provided in correspondence with one of the scanning lines, selects the first power supply line when the one of the scanning lines is selected and selects the second power supply line since the one of the scanning lines has been unselected until the one of the scanning lines is selected again, and applies the voltage of the selected power supply line to the capacitor line. Thus, it is possible to suppress the voltage amplitude of the data lines, and it is also possible to reduce power consumption generated by the parasitic capacitances in association with the data lines, while improving the display quality.

In addition, in a period during which all the scanning lines are not selected, the voltage of the second power supply line is forcibly applied to all the capacitor lines. Thus, even in the partial display mode of which the refresh period is long, it is possible to maintain the voltages of the capacitor lines at the voltage of the second power supply line. In this manner, it is possible to prevent the capacitor lines from entering a high impedance state and also possible to prevent the occurrence of poor display, such as flicker with a simple circuitry.

In addition, when the scanning line corresponding to one of the capacitor lines is selected, it is possible to apply the voltage of the first power supply line to the one of the capacitor lines in such a manner that a third transistor is made to enter an on state and a fourth transistor is made to enter an off state, while it is possible to apply the voltage of the second power supply line to the one of the capacitor lines in such a manner that the third transistor is made to enter an off state and the fourth transistor is made to enter an on state since a scanning line, which is spaced predetermined lines away from the one of the scanning lines and which is selected after the one of the scanning lines, has been selected until the one of the scanning lines is selected again. In this manner, only four TFTs are enough for driving a one capacitor line, and an additional control signal or control voltage is not necessary. Thus, without a complex circuitry of the capacitor line driving circuit, it is possible to suppress the voltage amplitude of the data lines.

Furthermore, because the electric potential of each capacitor line may be controlled with a binary gate voltage, it is possible to avoid an increase in packaging density or a complex circuitry that generates the waveform of a gate voltage. In addition, in a period during which all the scanning lines are not selected, the gate electrode of the fourth transistor is pulled up to the on voltage by a fifth transistor. Thus, even in the partial display mode of which a scanning cycle is long, it is possible to hold the voltage of each capacitor line at the voltage of the second power supply line. In this manner, it is possible to prevent the occurrence of poor display, such as flicker, with a simple circuitry.

Furthermore, when a scanning line, which is spaced predetermined lines away from the scanning line that corresponds to one of the capacitor lines, is selected, the voltage of the first power supply line and the voltage of the second power supply line are set so that the voltage of each capacitor line varies. Thus, each of the data signals supplied from the data line driving circuit may be set to a voltage that is determined by anticipating a variation in voltage of the pixel electrode in accordance with a variation in voltage of the capacitor line, so that it is possible to suppress the voltage amplitude of the data lines.

In addition, the voltage of the first power supply line is inverted between different two voltages at predetermined time intervals and the voltage of the second power supply line is constant. Thus, it is possible to suppress the voltage amplitude of the data lines and also possible to prevent adverse effects on the display quality due to a variation in voltage of the capacitor line in such a manner that, in a period during which one of the scanning lines is not selected, the voltage of the capacitor line that corresponds to the one of the scanning lines is stabilized at the voltage of the second power supply line.

Next, a second embodiment according to the invention will be described. The second embodiment differs from the above described first embodiment in that a correction circuit is additionally provided for supplying the first power supply line 168 with a voltage signal that makes, when the i-th scanning line 112 is selected, a detection voltage of the capacitor line 132 that corresponds to the i-th scanning line 112 become a target voltage.

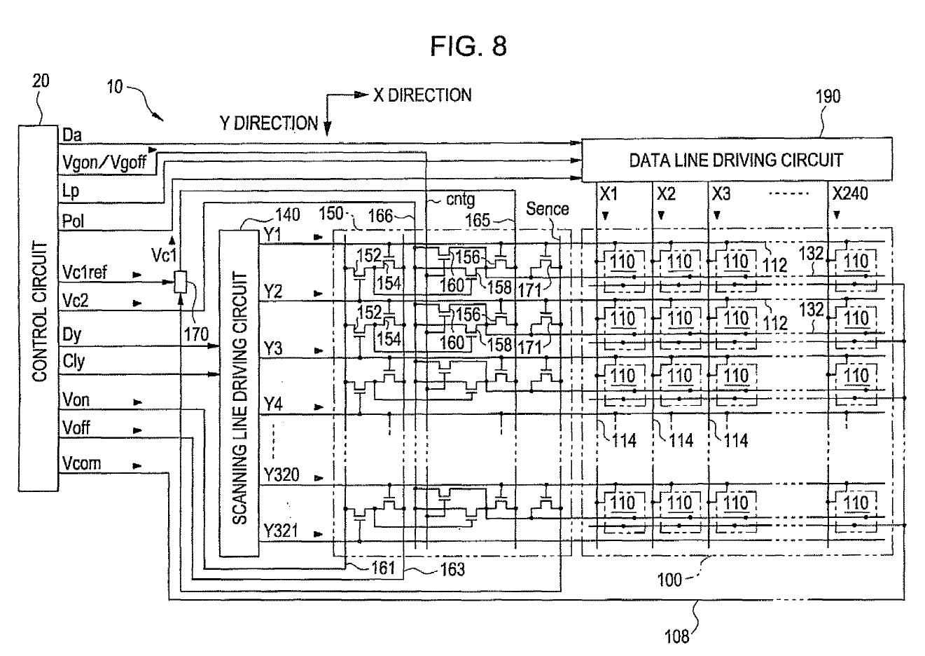

FIG. 8 is a block diagram that shows the configuration of the electro-optical device 10 according to the second embodiment. As shown in FIG. 8, the electro-optical device 10 according to the second embodiment has the same configuration as that shown in FIG. 1 except that a first capacitive signal output circuit 170 and TFTs 171 are additionally provided for the electro-optical device 10 shown in FIG. 1. Thus, the different portions in the configuration will be specifically described. The TFTs 171 are provided in correspondence with the first to 320th capacitor lines 132. When the TFT 171 corresponding to the i-th capacitor line 132 will be described, the gate electrode of the TFT 171 is connected to the i-th scanning line 112, the source electrode thereof is connected to an electric potential monitoring line Sence, and the drain electrode thereof is connected to the i-th capacitor line 132.

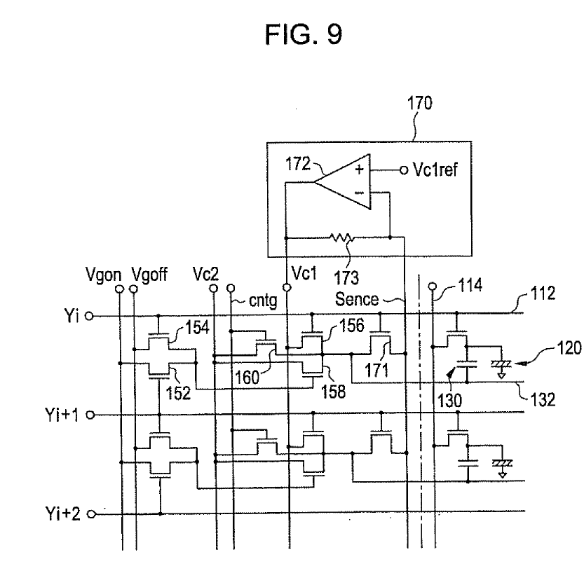

That is, the TFT 171 is in an on state in a period during which the scanning signal Yi is at an H level (a period during which the TFT 156 is in an on state) and applies the electric potential of the capacitor line 132 to the electric potential monitoring line Sence. The control circuit 20 performs control, or the like, of various portions in the electro-optical device 10 by outputting various control signals, and supplies a first target signal Vc1ref to the first capacitive signal output circuit 170. FIG. 9 is a view that shows the configuration of the first capacitive signal output circuit 170.

As shown in FIG. 9, the first capacitive signal output circuit 170 includes an operational amplifier 172 and a resistor 173. The output terminal of the operational amplifier 172 is connected to the on voltage supply line 161, and the electric potential monitoring line Sence is connected to the inverting input terminal (−) of the operational amplifier 172. In addition, the non-inverting input terminal (+) of the operational amplifier 172 is supplied with the first target signal Vc1ref from the control circuit 20. Then, the resistor 173 is connected between the output terminal and inverting input terminal (−) of the operational amplifier 172.

Owing to the above configuration, the first capacitive signal output circuit 170 outputs the first capacitive signal Vc1, on which negative feedback control is performed so that the voltage of the capacitor line 132 becomes the first target signal Vc1ref, to the on voltage supply line 161. Note that each of the TFTs 171 serves as a resistance. Here, the first capacitive signal output circuit 170 and the TFTs 171 constitute the correction circuit. Next, the operation of the second embodiment will be described.

The control circuit 20, over a period of the n-th frame, sets the polarity specifying signal Pol to an H level and sets the first target signal Vc1ref to the voltage Vsl. In addition, the control circuit 20, over a period of the (n+1)th frame, sets the polarity specifying signal Pol to an L level and sets the first target signal Vc1ref to the voltage Vsh. Here, the operation (full-screen display mode) in the n-th frame will be described. In the n-th frame, the scanning signal Y1 initially attains an H level by the scanning line driving circuit 140.

As the latch pulse Lp is output at the timing when the scanning signal Y1 attains an H level, the data line driving circuit 190 reads out the display data Da of the first, second, third, . . . , and 240th column pixels in the first row and converts the display data Da into the data signals X1, X2, X3, . . . , and X240 of voltages that are set to the higher side with reference to the voltage LCcom by the potentials of voltages specified by the display data Da, and then supplies the data signals to the first, second, third, . . . , and 240th data lines 114, respectively. Thus, the first row and first column to the first row and 240th column pixel capacitors 120 are written with positive polarity voltages corresponding to the respective gray scales.

On the other hand, when the scanning signal Y1 is at an H level, the TFTs 154 and 156 corresponding to the first capacitor line 132 enters an on state in the capacitor line driving circuit 150. As a result, the first capacitor line 132 is connected to the first power supply line 165. In the n-th frame, because the first power supply line 165 is supplied with the first capacitive signal Vc1 that is controlled to become the voltage Vsl of the first target signal Vc1ref by the first capacitive signal output circuit 170, the voltage of the first capacitor line 132 becomes the voltage Vsl. Thus, the first row and first column to the first row and 240th column storage capacitors 130 are written with voltage differences between the voltage Vsl and positive polarity voltages corresponding to the respective gray scales.

Next, the scanning signal attains an L level and, at the same time, the scanning signal Y2 attains an H level. As the latch pulse Lp is output at the timing when the scanning signal Y2 attains an H level, the data line driving circuit 190 supplies the data signals X1, X2, X3, . . . , and X240 of positive polarity voltages corresponding to the gray scales of the first, second, third, . . . , and 240th column pixels in the second row to the first, second, third, . . . , and 240th data lines 114, respectively. In this manner, the second row and first column to the second row and 240th column pixel capacitors 120 are written with positive polarity voltages corresponding to the respective gray scales.

On the other hand, as the scanning signal Y1 attains an L level, the TFTs 116 in the first row and first column to the first row and 240th column pixels each enter an off state. In addition, when the scanning signal Y1 is at an L level, in the capacitor line driving circuit 150, the TFTs 154 and 156 corresponding to the first capacitor line 132 both enter an off state and, because the scanning signal Y2 is at an H level, the TFT 152 corresponding to the first capacitor line 132 enters an on state. As a result, the TFT 158 corresponding to the first capacitor line 132 enters an on state, the first capacitor line 132 is connected to the second power supply line 166 and, thereby, the voltage of the first capacitor line 132 maintains the voltage Vsl. Thus, the second row and first column to the second row and 240th column storage capacitors 130 are written with voltage differences between the voltage Vsl and positive polarity voltages corresponding to the respective gray scales.

In a period of the n-th frame during which the polarity specifying signal Pol is at an H level, the same operation will be repeated until the scanning signal Y320 attains an H level. In this manner, the first capacitive signal output circuit 170 outputs the first capacitive signal Vc1 to the on voltage supply line 161 so that the voltage of the capacitor line 132, detected through the electric potential monitoring line Sence, becomes the first target signal Vc1ref. Thus, the voltage of the i-th capacitor line 132, in a period during which the scanning signal Yi is at an H level, is held at the voltage vsl when positive polarity writing is specified or is held at the voltage Vsh when negative polarity writing is specified, even when there is an influence, such as noise.

Therefore, even when the on resistance of the TFT 156 is large, a voltage distortion, which may be generated in the capacitor line 132, does not occur and, as a result, display chrominance non-uniformity, or the like, does not occur. In this manner, in the second embodiment, when the scanning line of a certain line is selected, the voltage of the capacitor line in that line is corrected to be the voltage of the first target signal. Thus, even when the on resistance of the third transistor is increased, there is no possibility that a voltage distortion, which may be generated in the capacitor line, never occurs and, hence, the occurrence of display chrominance non-uniformity, or the like, is prevented. Thus, it is possible to improve the display quality. In addition, because the size of each of the third transistors may be reduced, it is possible to reduce the area of a so-called window-frame region located outside the display area and also possible to reduce the costs.

Note that, in the above embodiments, the case in which the second capacitive signal Vc2 is constant at the voltage Vsl; however, it is applicable that the second capacitive signal Vc2 is constant at the voltage Vsh. Furthermore, it is also applicable that the second capacitive signal Vc2 is constant at a voltage that is intermediate between the voltage Vsl and the voltage Vsh.

In addition, in the above embodiments, the case in which the electro-optical device is driven in a surface inversion mode is described; however, it is applicable that the electro-optical device is driven in a line inversion mode in which writing polarity is inverted once every line. In this case, the second capacitive signal Vc2 may be constant at the voltage Vsl or may be constant at the voltage Vsh. In addition, the second capacitive signal Vc2 may be constant at the voltage LCcom.

Furthermore, in the above embodiments, the case in which, in the partial display mode, in a period during which all the scanning lines are not selected, the TFTs 160 are made to enter an on state to set the voltages of all the capacitor lines to the voltage of the second power supply line is described. However, for example, irrespective of the display mode, in a period during which all the scanning lines are not selected, such as a period from time when the scanning signal Yi attains an L level to time when the next scanning signal Y(i+1) attains an H level or a blanking period of predetermined time intervals at which positive polarity writing and negative polarity writing are switched, the TFTs 160 may be made to enter an on state.

In addition, in the above embodiments, the case in which, in the capacitor line driving circuit 150, the gate electrode of the TFT 152 corresponding to the i-th capacitor line 132 is connected to the next (i+1)th scanning line 112 is described; however, it is applicable that the gate electrode of the TFT 152 is connected to the scanning line 112 that is spaced a certain number of lines m (m is an integer that is equal to or more than two) away from the i-th capacitor line 132. Furthermore, in the above embodiments, the case in which m dummy scanning lines 112 are required in order to drive the TFT 152 that corresponds to the last 320th capacitor line 132 is described; however, it is applicable that, when m is, for example, “1”, a retrace period Fb is omitted and the gate electrode of the TFT 152 corresponding to the 320th capacitor line 132 is connected to the first scanning line 112, and then the dummy scanning line is not required.

In addition, in the above embodiments, the case in which the aspect of the invention is applied to the electro-optical device that uses a liquid crystal is described; however, the aspect of the invention may also be applicable to the electro-optical device that uses an electrooptic material other than the liquid crystal. For example, the aspects of the invention may be applied to various electro-optical devices that include a display panel that uses an OLED element, such as organic EL or a light emitting polymer, as the electrooptic material, an electrophoretic display panel that uses a microcapsule containing pigmented liquid and white particles dispersed in the liquid, a twist ball display panel that uses a twist ball that is painted to have different colors between the regions that are different in polarity as the electrooptic material, a toner display panel that uses black toner as an electrooptic material, and a plasma display panel that uses high-pressure gas, such as helium, neon, or the like, as an electrooptic material. Thus, the aspect of the invention may be applied to various electro-optical devices.

### Third Embodiment

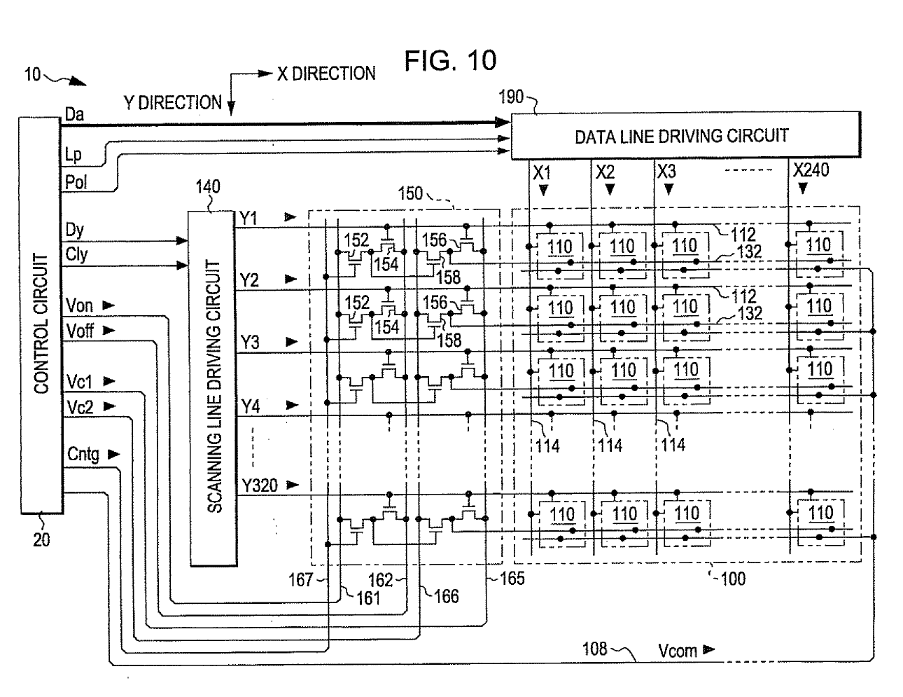

Next, a third embodiment according to the invention will be described. FIG. 10 is a block diagram that shows the configuration of an electro-optical device according to the third embodiment of the invention. As shown in the drawing, the electro-optical device 10 has a display area 100 and arranges a scanning line driving circuit 140, a capacitor line driving circuit 150 and a data line driving circuit 190 around the display area 100. The display area 100 is an area in which pixels 110 are arranged. In the present embodiment, 320 scanning lines 112 are provided to extend in a row direction (X) direction, while 240 data lines 114 are provided to extend in a column (Y) direction. Then, the pixels 110 are arranged at positions corresponding to intersections of the first to 320th scanning lines 112 and the first to 240th data lines 114. Thus, in the present embodiment, the pixels 110 are arranged in the display area 100 in a matrix of 320 rows by 240 columns. In addition, capacitor lines 132 are provided to extend in the X direction in correspondence with the first to 320th scanning lines 112. Thus, the capacitor lines 132 are provided from the first line to the 320th line.

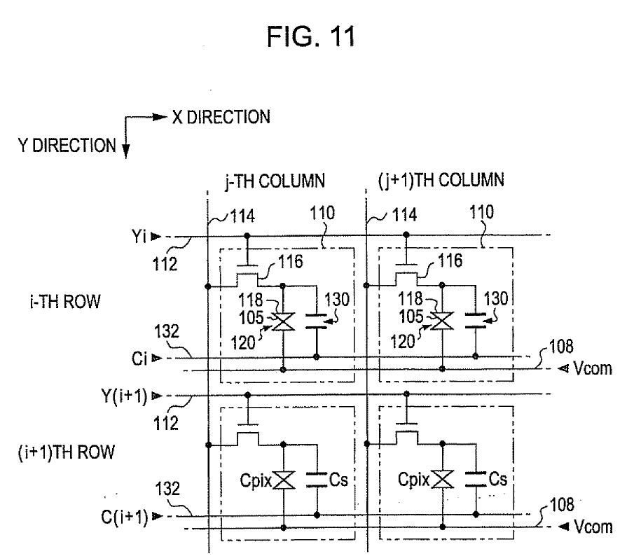

Here, the detailed configuration of the pixels 110 will be described. FIG. 11 is a view that shows the configuration of the pixels 110, showing the configuration of 2 by 2 pixels, that is, four pixels in total, corresponding to intersections of the i-th row and the (i+1)th row located adjacent to the i-th row, the j-th column and the (i+1)th column located adjacent to the j-th column. Here, i is a symbol that generally indicates a row in which the pixels 110 are arranged and, in the present embodiment, is an integer that ranges from 1 to 320. In addition, j and (j+1) are symbols that generally indicate a column in which the pixels 110 are arranged and are integers, each of which ranges from 1 to 240.

As shown in FIG. 11, each of the pixels 110 includes an n-channel thin-film transistor (hereinafter, simply referred to as TFT) 116 that functions as a pixel switching element, a pixel capacitor (liquid crystal capacitor) 120 and a storage capacitor 130. Here, because each of the pixels 110 has the same configuration, the description will be made representatively using the pixel 110 located at the i-th row and j-th column. In the i-th row and j-th column pixel 110, the gate electrode of the TFT 116 is connected to the i-th scanning line 112, the source electrode thereof is connected to the j-th column data line 114, and the drain electrode thereof is connected to a pixel electrode 118, which is one terminal of the pixel capacitor 120. In addition, the other terminal of the pixel capacitor 120 is connected to a common electrode 108. The common electrode 108, as shown in FIG. 10, is common to all the pixels 110 and is supplied with a common signal Vcom. Here, in the present embodiment, the common signal Vcom is constant at a voltage LCcom in terms of time, as will be described later. Note that, in FIG. 11, Yi and Y(i+1) respectively represent scanning signals supplied to the i-th and (i+1)th scanning lines 112, and Ci and C(i+1) respectively represent voltages of the i-th and (i+1)th capacitor lines 132.

The display area 100 includes a pair of element substrate, on which the pixel electrodes 118 are formed, and opposite substrate, on which the common electrode 108 is formed. The element substrate and the opposite substrate are spaced at a certain gap in between, and adhered so that electrode forming faces of both substrates are opposite each other. Then, a liquid crystal 105 is sealed in the gap. Therefore, each of the pixel capacitors 120 is formed to hold the liquid crystal 105, which is a kind of dielectric, with the pixel electrode 118 and the common electrode 108, and is configured to hold a voltage difference between the pixel electrode 118 and the common electrode 108. Note that, in each of the pixel capacitors 120, the amount of transmitted light thereof varies depending on the effective value of the holding voltage, and the present embodiment employs a normally white mode, for easier description, in which the transmittance ratio of light becomes maximum to perform white display when the effective value of a voltage held in the pixel capacitor 120 is close to zero, while the amount of light transmitted reduces as the effective value of a voltage increases and, finally, the transmittance ratio becomes minimum to perform black display.

In addition, one terminal of the storage capacitor 130 in the i-th row and j-th column pixel 110 is connected to the pixel electrode 118 (drain electrode of the TFT 116), and the other terminal is connected to the i-th capacitor line 132. Thus, the storage capacitor 130 is electrically connected between the pixel electrode 118, which is one terminal of the pixel capacitor 120, and the i-th capacitor line 132. Note that the capacitance of the pixel capacitor 120 and the capacitance of the storage capacitor 130 are denoted as Cpix and Cs, respectively.

Referring back to FIG. 10, the control circuit 20 outputs various control signals, such as a clock signal Cly, a start pulse Dy, a latch pulse Lp and a polarity specifying signal Pol, to perform control, or the like, on various portions of the electro-optical device 10, and supplies a first capacitive signal Vc1 to a first power supply line 165, a second capacitive signal Vc2 to a second power supply line 166 and a gate control signal Cntg to a gate control line 167. Furthermore, the control circuit 20 supplies an on voltage Von, which will be described later, to an on voltage supply line 161 and supplies an off voltage Voff to an off voltage supply line 163, and, in addition, supplies a common signal Vcom to the common electrode 108.

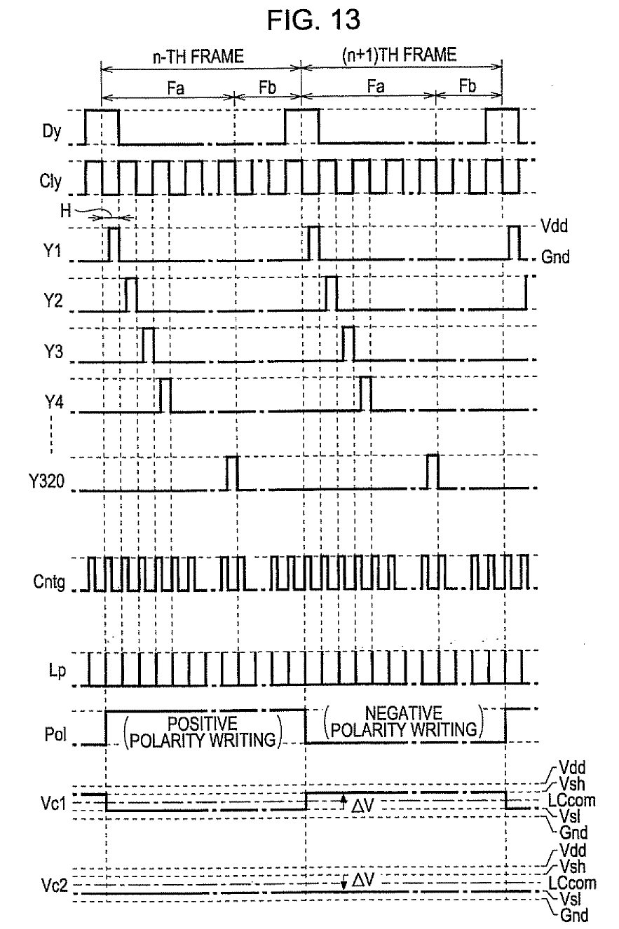

Peripheral circuits, such as the scanning line driving circuit 140, the capacitor line driving circuit 150, and the data line driving circuit 190, are provided around the display area 100. The scanning line driving circuit 140, in accordance with the control by the control circuit 20, supplies scanning signals Y1, Y2, Y3, . . . , and Y320 to the first, second, third, . . . , and 320th scanning lines 112, respectively. Each of the scanning signals Y1 to Y320, as shown in FIG. 13, is a pulse that maintains an H level with a width shorter than half the cycle of the clock signal Cly of a duty ratio 50%, and the pulses of the scanning signals Y1 to Y320 are sequentially delayed by half the cycle of the clock signal C1y from Y1 to Y320. Thus, the pulses of the scanning signals for the adjacent lines are output with a period, during which the pulse is at an L level, interposed therebetween.

The scanning line driving circuit 140 outputs such scanning signals Y1 to Y320 in such a manner that the start pulse Dy supplied, for example, from the control circuit 20 is sequentially shifted in accordance with the clock signal Cly and the width of the pulse is reduced; however, a detailed description is omitted. Note that the H level of each of the scanning signals Y1 to Y320 corresponds to a selection voltage Vdd and the L level corresponds to a non-selection voltage (ground electric potential Gnd). Here, the scanning line is selected when the scanning signal is at an H level, and is not selected when the scanning signal is at an L level. In addition, in the present embodiment, the period of one frame means a period required to display one screen image and, as shown in the drawing, is divided into an effective scanning period Fa, during which the scanning signals Y1 to Y320 sequentially attain an H level and the scanning lines are sequentially scanned (selected), and a retrace period Fb other than the above period. However, it is not necessary to provide the retrace period Fb.

In the present embodiment, the capacitor line driving circuit 150 is formed of a set of n-channel TFTs 152, 154, 156 and 158 that are provided in correspondence with each of the first to 320th capacitor lines 132. Here, when the TFTs 152, 154, 156 and 158 corresponding to the i-th capacitor line 132 will be described, the gate electrode of the TFT 152 (first transistor) is connected to the gate control line 167, the source electrode thereof is connected to the on voltage supply line 161, while the gate electrode of the TFT 154 (second transistor) is connected to the i-th scanning line 112 and the source electrode thereof is connected to the off voltage supply line 162, and then both the drain electrodes of the TFTs 152 and 154 are commonly connected to the gate electrode of the TFT 158. In addition, the gate electrode of the i-th TFT 156 (third transistor) is connected to the i-th scanning line 112 and the source electrode thereof is connected to the first power supply line 165, while the source electrode of the TFT 158 (fourth transistor) is connected to the second power supply line 166, and then both the drain electrodes of the TFTs 156 and 158 are commonly connected to the i-th capacitor line 132.

Here, the on voltage Von, which is supplied to the on voltage supply line 161, is a voltage that makes the TFT 158 enter an on state (a conductive state between the source and drain electrodes) when it is applied to the gate electrode of the TFT 158. The on voltage Von is, for example, a voltage Vdd that is the same as the H level of the scanning signal. In addition, the off voltage Voff, which is supplied to the off voltage supply line 163, is a voltage that makes the TFT 158 enter an off state (a non-conductive state between the source and drain electrodes) even when it is applied to the gate electrode of the TFT 158. The off voltage is, for example, a zero voltage (ground electric potential Gnd) that is the same as the L level of the scanning signal.

The data line driving circuit 190 supplies the first, second, third, . . . , and 240th data lines 114 with voltages that correspond to gray scales of the pixels 110 located on the scanning line 112 that is scanned by the scanning line driving circuit 140 and that are data signals X1, X2, X3, . . . , and X240 of voltages with polarity that is specified by the polarity specifying signal Pol. Here, the data line driving circuit 190 has storage areas (not shown) corresponding to matrix arrangement of 320 rows by 240 columns. Each of the storage areas stores display data Da that specify a gray-scale value (brightness) of the corresponding pixel 110. The display data Da stored in each of the storage areas, when the content of display needs to be changed, are updated in such a manner that display data Da after being changed is supplied together with the address by the control circuit 20. The data line driving circuit 190 reads out the display data Da of the pixels 110, which are located on the selected (scanned) scanning line 112, from the storage areas and converts the read display data Da into data signals of voltages that correspond to the gray-scale values and that have specified voltage polarity, and then executes the operation to supply the data signals to the first to 240th data lines 114 that are located on the selected scanning line 112.

The polarity specifying signal Po1 is a signal that specifies positive polarity writing when it is at an H level or that specifies negative polarity writing when it is at an L level. As shown in FIG. 13, in the present embodiment, the polarity specifying signal Pol inverts its polarity once in every period of one frame. Thus, in the present embodiment, polarity written to the pixels in a period of one frame is set the same, and a surface inversion driving by which the writing polarity is inverted once in every period of one frame is employed. The reason why the polarity is inverted as described above is to prevent degradation of the liquid crystal due to an applied direct-current component. In addition, in regard to the writing polarity in the present embodiment, in the case where a voltage corresponding to a gray scale is held in the pixel capacitor 120, the polarity is positive when the voltage of the pixel electrode 118 is higher than the voltage LCcom of the common electrode 108, while the polarity is negative when the voltage of the pixel electrode 118 is lower than the voltage LCcom. On the other hand, the voltage uses the ground electric potential Gnd (voltage zero) of power supply as the reference, unless otherwise stated.

Note that the control circuit 20 supplies a latch pulse Lp to the data line driving circuit 190 at the timing when the logic level of the clock signal Cly changes (rises or falls). As described above, the scanning signals Y1 to Y320 have such relationship that a pulse, having a width that is narrower than half the cycle of the clock signal Cly, is sequentially delayed by half the cycle of the clock signal Cly from Y1 to Y320, so that the scanning signals each attain an H level using the timing, at which the logic level of the clock signal Cly shifts, as a reference. Note that, in details, as shown in FIG. 13, it is set so that the scanning signals each attain an H level at the timing that is delayed by predetermined time from the timing at which the logic level of the clock signal Cly shifts. In this manner, because the scanning signals each attain an H level using the shift timing of the clock signal Cly as a reference, the data line driving circuit 190 is able to recognize which one of the scanning lines attains an H level by, for example, continuously counting the latch pulse Lp over a period of one frame and is also able to recognize the timing at which the scanning signal attains an H level on the basis of the timing to output the latch pulse Lp.

In addition, the control circuit 20 outputs the following gate control signal Cntg. That is, the control circuit 20, as shown in FIG. 13, outputs a pulse-like gate control signal Cntg, which is at an H level in a period during which all the scanning signals Y1 to Y320 are at an L level, once every half cycle of the clock signal Cly, that is, every time the scanning line is selected.

In the present embodiment, on the element substrate, in addition to the scanning lines 112, the data lines 114, the TFTs 116, the pixel electrodes 118 and the storage capacitors 130 in the display area 100, the TFTs 152, 154, 156 and 158, the on voltage supply line 161, the off voltage supply line 162, the first power supply line 165, the second power supply line 166, the gate control line 167, and the like, in the capacitor line driving circuit 150 are formed.

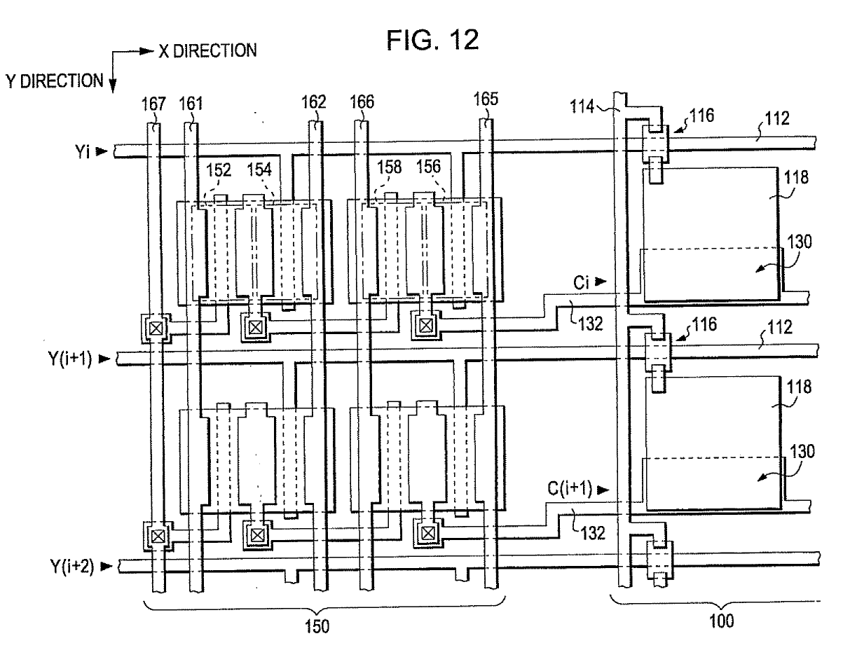

FIG. 12 is a plan view that shows the configuration around the boundary between the capacitor line driving circuit 150 and the display area 100 within the above described element substrate. As shown in the drawing, in the present embodiment, the TFTs 116, 152, 154, 156 and 158 each are of an amorphous silicon type and a bottom gate type in which the gate electrode of each of them is located on the lower side than the semiconductor layer. Specifically, the scanning lines 112, the capacitor lines 132 and the gate electrodes of the TFTs 152 and 158 are formed by patterning a gate electrode layer, which serves as a first conductive layer, and a gate insulating film (not shown) is formed thereon. Furthermore, the semiconductor layers of the TFTs 116, 152, 154, 156 and 158 are formed in an island shape. On the semiconductor layer, the rectangular pixel electrodes 118 are formed by patterning an ITO (indium tin oxide) layer, which serves as a second conductive layer, through a protective layer (not shown), and, furthermore, the data lines 114, which serve as the source electrodes of the TFTs 116, the on voltage supply line 161, which serves as the source electrodes of the TFTs 152, the off voltage supply line 163, which serves as the source electrodes of the TFTs 154, the first power supply line 165, which serves as the source electrodes of the TFTs 156, the second power supply line 166, which serves as the source electrodes of the TFTs 158, the common drain electrodes of the TFTs 152 and 153, the common drain electrodes of the TFTs 156 and 158 and the gate control line 167 are formed by patterning a metal layer, such as aluminum, which serves as a third conductive layer.

Here, the gate electrodes of the TFTs 154 and 156 are portions that are branched from the scanning line 112 in the Y (downward) direction in a T shape. In addition, the L-shaped gate electrode of the TFT 152 underlies the on voltage supply line 161 and is connected to the gate control line 167 through a contact hole (indicated by the symbol × in the drawing) that extends through the gate insulating film. Similarly, the L-shaped gate electrode of the TFT 158 underlies both the second power supply line 166 and the off voltage supply line 162 and is connected to the common drain electrode of the TFTs 152 and 154 through a contact hole that extends through the gate insulating film. In addition, each of the storage capacitors 130 is configured so that part of the capacitor line 132, which is formed in the lower layer relative to the pixel electrode 118 so as to have a large width, and the pixel electrode 118 hold the above gate insulating film as a dielectric. In addition, the common drain electrode of the TFTs 156 and 158 is connected to the capacitor line 132 through a contact hole that extends through the gate insulating film. Note that the common electrode 108 that is opposed to the pixel electrodes 118 is formed on the opposite substrate, so that it is not shown in FIG. 12 that shows a plan view of the element substrate.

The configuration shown in FIG. 12 is just illustrative, and the type of a TFT may be another structure, for example, a top-gate type in terms of the arrangement of the gate electrode or a polysilicon type in terms of a process. In FIG. 12, where the transistor sizes of the TFTs 152, 154, 156 and 158 are respectively represented as Tr1, Tr2, Tr3 and Tr4, the sizes of them are substantially set equal so that Tr1=Tr2=Tr3=Tr4; however, as will be described later, because it is desirable that the on resistance of the TFT 156 is smaller, the sizes may be set so that Tr3≧Tr4≧Tr1=Tr2.

Furthermore, it is applicable that the element of the capacitor line driving circuit 150 is not mounted in the display area 100 but an IC chip is mounted on the element substrate. When the IC chip is mounted on the element substrate, the scanning line driving circuit 140 and the capacitor line driving circuit 150 may be integrally formed as a semiconductor chip together with the data line driving circuit 190 or may be separately formed. In addition, the control circuit 20 may be connected through an FPC (flexible printed circuit) substrate, or the like, or may be mounted on the element substrate as a semiconductor chip. In addition, when the present embodiment is configured not as a transmissive type but as a reflective type, the pixel electrodes 118 may be formed by patterning a reflective conductive layer or may be formed with an additional reflective metal layer. Furthermore, a so-called transflective type in which both the transmissive type and the reflective type are combined may be employed.

Next, the operation of the electro-optical device 10 according to the present embodiment will be described. In the present embodiment as described above, writing polarity to the pixels is driven in a surface inversion mode. Thus, the control circuit 20, as shown in FIG. 13, specifies positive polarity writing by setting the polarity specifying signal Pol to an H level in a period of a certain frame (denoted as “n-th frame) and specifies negative polarity writing by setting the polarity specifying signal Pol to an L level in a period of the next (n+1)th frame. That is, the control circuit 20 specifies inversion of writing polarity once in every period of one frame. In addition, the control circuit 20, in the n-th frame, sets a first capacitive signal Vcl and a second capacitive signal Vc2 to the same electric potential and, in the (n+1)th frame, sets the first capacitive signal Vc1 to a voltage that is increased by a voltage ΔV relative to the second capacitive signal Vc2. Thus, as shown in FIG. 13, when the second capacitive signal Vc2 is constant at the voltage Vsl irrespective of writing polarity, the first capacitive signal Vc1 is the voltage Vsl that is the same as the second capacitive signal Vc2 in the n-th frame and is the voltage Vsh that is higher by ΔV than the voltage Vsl in the (n+1)th frame.

Note that, in the present embodiment, the voltage Vsl is lower than the voltage LCcom and the voltage Vsh is higher than the voltage LCcom. Both the voltages Vsl and Vsh are symmetrical with respect to the voltage LCcom and the absolute value of a difference therebetween is ΔV. In addition, the relationship in the level of a voltage in the present embodiment is Gnd<Vsl<LCcom<Vsh<Vdd.

Incidentally, in the n-th frame, the scanning signal Y1 initially attains an H level by the scanning line driving circuit 140; however, as the latch pulse Lp is output immediately before the scanning signal Y1 attains an H level, the data line driving circuit 190 reads out the display data Da of the first, second, third, . . . , and 240th column pixels in the first row and converts the display data Da into the data signals X1, X2, X3, . . . , and X240 of voltages that are set to the higher side with reference to the voltage LCcom by the potentials of voltages specified by the display data Da, and then supplies the data signals to the first, second, third, . . . , and 240th data lines 114, respectively. In this manner, for example, the j-th data line 114 is applied with a positive polarity voltage that is set to the higher side with reference to the voltage LCcom by the potential of a voltage specified by the display data Da of the first row and j-th column pixel 110 as the data signal Xj.

Note that, in the present embodiment, at the time when the data line driving circuit 190 applies the first to 240th data lines 114 with the data signals X1 to X240, the gate control signal Cntg is at an H level. When the gate control signal Cntg is at an H level, in the capacitor line driving circuit 150, the TFTs 152 corresponding to all the first to 320th capacitor lines 132 enter an on state and the TFTs 154 and 156 corresponding to all the first to 320th capacitor lines 132 enter an off state, so that the gate electrodes of the TFTs 158 are applied with the on voltage Von that is supplied to the on voltage supply line 161. Thus, all the TFTs 158 enter an on state, so that the first to 320th capacitor lines 132 are connected to the second power supply line 166 to be applied with the voltage Vsl.

Next, as the scanning signal Y1 attains an H level, the TFTs 116 in the first row and first column to the first row and 240th column enter an on state. Thus, these pixel electrodes 118 are applied with the data signals X1, X2, X3, . . . , and X240, respectively. Thus, the first row and first column to the first row and 240th column pixel capacitors 120 each are written with a voltage difference between the voltage of the data signal applied to the pixel electrode 118 and the voltage LCcom applied to the common electrode 108, that is, a polarity voltage corresponding to a gray scale.

On the other hand, when the scanning signal Y1 is at an H level, the gate control signal Cntg is at an L level. Thus, in the capacitor line driving circuit 150, the TFT 152 corresponding to the first capacitor line 132 enters an off state and the TFT 154 corresponding to the first capacitor line 132 enters an on state. Thus, the gate electrode of the first TFT 158 is connected to the off voltage supply line 162 to be applied with the off voltage Voff, so that the first TFT 158 enters an off state. In addition, when the scanning signal Y1 is at an H level, the first TFT 156 enters an on state. Thus, the first capacitor line 132 is connected to the first power supply line 165 to be applied with the voltage Vsl. Thus, the first row and first column to the first row and 240th column storage capacitors 130 each are written with a voltage difference between the voltage of the data signal applied to the pixel electrode 118 and the voltage Vsl.

Note that, in the capacitor lines 132 other than the first line, the following situation occurs. That is, when the scanning signal Y1 is at an H level, the TFTs 152, 154 and 156 in the lines other than the first line all enter an off state; however, the gate electrodes of the TFTs 158 in the lines other than the first line hold the voltage Von in the immediately preceding state by their parasitic capacitances. Thus, because the TFTs 158 in the lines other than the first line maintain an on state, the second to 130th capacitor lines 132 other than the first line are connected to the second power supply line 166 and determined to be applied with the voltage Vs1.

Next, the scanning signal Y1 attains an L level; however, before the scanning signal Y2 attains an H level, that is, in a period during which all the scanning signals are at an L level, the gate control signal Cntg is at an H level. Thus, in the capacitor line driving circuit 150, the TFTs 152 corresponding to all the first to 320th capacitor lines 132 enter an on state, so that the gate electrodes of the TFTs 158 are applied with the on voltage Von again. Thus, all the TFTs 158 enter an on state, so that the first to 320th capacitor lines 132 are connected to the second power supply line 166 to be applied with the voltage Vsl. In addition, as the scanning signal Y1 attains an L level, the TFTs 116 in the first row and first column to the first row and 240th column pixels enter an off state, so that the pixel electrodes 118 are released from the connection with the data lines 114. Thus, a series circuit formed of the pixel capacitor 120 and the storage capacitor 130 in each of the first row and first column to the first row and 240th column pixels is electrically connected between the common electrode 108 and the capacitor line 132. However, in the n-th frame, because the first capacitive signal Vc1 supplied to the first power supply line 165 and the second capacitive signal Vc2 supplied to the second power supply line 166 have the same voltage Vsl, the voltage of each capacitor line 132 does not change. Note that the common electrode 108 is constant at the voltage LCcom. Thus, in the n-th frame, when the scanning signal Y1 is at an H level, the voltages written to the first row and first column to the first row and 240th column pixel capacitors 120 and storage capacitors 130 never vary.

Subsequently, the scanning signal Y2 attains an H level; however, as the latch pulse Lp is output immediately before the scanning signal Y2 attains an H level, the data line driving circuit 190 reads out the display data Da of the first, second, third, . . . , and 240th column pixels in the second row and converts the display data Da into the data signals X1, X2, X3, . . . , and X240 corresponding to positive polarity, and then supplies the data signals to the first, second, third, . . . , and 240th data lines 114, respectively. Then, as the scanning signal Y2 attains an H level, the TFTs 116 in the second row and first column to the second row and 240th column enter an on state. Thus, these pixel electrodes 118 are applied with the data signals X1, X2, X3, . . . , and X240, respectively. Thus, the second row and first column to the second row and 240th column pixel capacitors 120 each are written with a voltage difference between the voltage of the data signal applied to the pixel electrode 118 and the voltage LCcom applied to the common electrode 108.

On the other hand, when the scanning signal Y2 is at an H level, the gate control signal Cntg is at an L level. Thus, in the capacitor line driving circuit 150, the TFT 152 corresponding to the second capacitor line 132 enters an off state and the TFT 154 corresponding to the second capacitor line 132 enters an on state. Thus, the gate electrode of the second TFT 158 is applied with the off voltage Voff, so that the second TFT 158 enters an off state. In addition, when the scanning signal Y2 is at an H level, the second TFT 156 enters an on state. Thus, the second capacitor line 132 is connected to the first power supply line 165 to be applied with the voltage Vs1. Thus, the second row and first column to the second row and 240th column storage capacitors 130 each are written with a voltage difference between the voltage of the data signal applied to the pixel electrode 118 and the voltage Vsl. Note that, when the scanning signal Y2 is at an H level, the TFTs 152, 154 and 156 in the lines other than the second line all enter an off state; however, the gate electrodes of the TFTs 158 in the lines other than the second line hold the voltage Von in the immediately preceding state by their parasitic capacitances. Thus, because the TFTs 158 in the lines other than the second line maintain an on state, the first and the third to 130th capacitor lines 132 other than the second line are connected to the second power supply line 166 and determined to be applied with the voltage Vsl.

Next, the scanning signal Y2 attains an L level; however, before the scanning signal Y3 attains an H level, the gate control signal Cntg attains an H level, so that all the TFTs 152 enter an on state and the gate electrodes of the TFTs 158 are applied with the on voltage again. Thus, all the TFTs 158 enter an on state, so that the first to 320th capacitor lines 132 are connected to the second power supply line 166 to be applied with the voltage Vsl. In addition, as the scanning signal Y2 attains an L level, the TFTs 116 in the second row and first column to the second row and 240th column pixels each enter an off state. However, in the n-th frame, the voltage of each capacitor line 132 does not change, and the common electrode 108 is also constant at the voltage LCcom. Thus, the voltages written to the second row and first column to the second row and 240th column pixel capacitors 120 and storage capacitors 130 when the scanning signal Y2 is at an H level never vary.

Subsequently, the scanning signal Y3 attains an H level; however, as the latch pulse Lp is output immediately before the scanning signal Y3 attains an H level, the data line driving circuit 190 reads out the display data Da of the first, second, third, . . . , and 240th column pixels in the third row and converts the display data Da into the data signals X1, X2, X3, . . . , and X240 corresponding to positive polarity, and then supplies the data signals to the first, second, third, . . . , and 240th data lines 114, respectively. Here, as the scanning signal Y3 attains an H level, the TFTs 116 in the third row and first column to the third row and 240th column pixels enter an on state. Thus, these pixel electrodes 118 are applied with the data signals X1, X2, X3, . . . , and X240 and, thereby, the third row and first column to the third row and 240th column pixel capacitors 120 each are applied with a voltage difference between the voltage of the data signal applied to the pixel electrode 118 and the voltage LCcom applied to the common electrode 108. On the other hand, when the scanning signal Y3 is at an H level, the gate control signal Cntg is at an L level. Thus, in the capacitor line driving circuit 150, the TFT 152 corresponding to the third capacitor line 132 enters an off state and the TFTs 154 and 156 corresponding to the third capacitor line 132 enter an on state. As a result, the third capacitor line 132 is connected to the first power supply line 165 to be applied with the voltage Vsl. Thus, the third row and first column to the third row and 240th column storage capacitors 130 each are written with a voltage difference between the voltage of the data signal applied to the pixel electrode 118 and the voltage Vsl. Note that, when the scanning signal Y3 is at an H level, the TFTs 152, 154 and 156 in the lines other than the third line all enter an off state; however, the gate electrodes of the TFTs 158 in the lines other than the third line hold the voltage Von by their parasitic capacitances, and the on states of the TFTs 158 other than the third line are maintained. Thus, the capacitor lines 132 other than the third line are connected to the second power supply line 166 and determined to be applied with the voltage Vsl.

In a period of the n-th frame during which the polarity specifying signal Pol is at an H level, the same operation will be repeated until the scanning signal Y320 attains an H level. In this manner, all the pixel capacitors 120 each continue to hold a voltage difference between the voltage of the data signal applied to the pixel electrode 118 and the voltage LCcom of the common electrode 108, and the storage capacitors 130 each continue to hold a voltage difference between the voltage of the data signal and the voltage Vsl.

Next, the operation in the (n+1)th frame during which the polarity specifying signal Pol is at an L level will be described. The operation in the (n+1)th frame differs from the operation in the n-th frame mainly in the following two points. That is, the operation in the (n+1)th frame differs from the operation in the n-th frame in that, firstly, the control circuit 20 sets the first capacitive signal Vc1 to the voltage Vsh that is higher by ΔV than the voltage Vsl as shown in FIG. 13, and, secondly, as the latch pulse Lp is output at the timing immediately before the scanning signal Yi attains an H level, the data line driving circuit 190 reads out the display data Da of the first, second, third, . . . , and 240th column pixels in the first row and sets the data signals X1, X2, X3, . . . , and X240 to the voltages that correspond to the display data Da and that correspond to negative polarity (this meaning will be described later). Then, the operation in the (n+1)th frame will be specifically described in the above different points and will be described in view of how the voltage written to the i-th row and j-th column pixel capacitor 120 varies when the scanning signal Yi attains an H level.

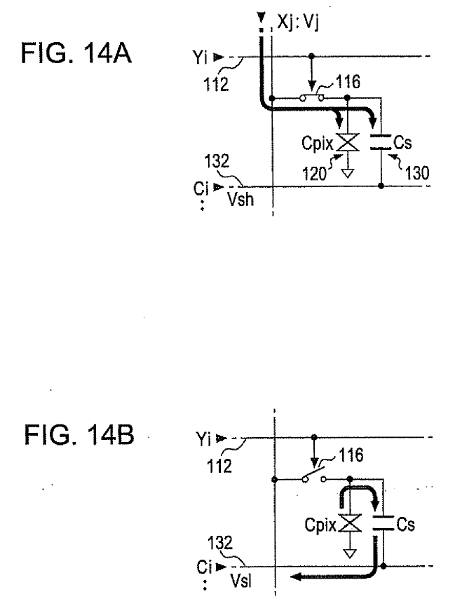

FIG. 14A and FIG. 14B are views, each of which illustrates a variation in the voltage of the i-th row and j-th column pixel capacitor 120 in the (n+1)th frame. First, as the scanning signal Yi attains an H level, as shown in FIG. 14A, the i-th row and j-th column TFT 116 enters an on state. Thus, the data signal Xj is applied to both one terminal (pixel electrode 118) of the pixel capacitor 120 and one terminal of the storage capacitor 130. On the other hand, when the scanning signal Yi is at an H level, in the capacitor line driving circuit 150, the TFTs 154 and 156 corresponding to the i-th capacitor line 132 enter an on state and the TFTs 152 and 158 enter an off state. Thus, the voltage Ci of the i-th capacitor line 132 will be the voltage Vsh of the first power supply line 165. Note that the common electrode 108 is constant at the voltage LCcom. Thus, where the voltage of the data signal Xj at this time is Vj, the i-th row and j-th column pixel capacitor 120 is charged with a voltage (Vj-LCcom), and the storage capacitor 130 is charged with a voltage (Vj-Vsh).

Next, the scanning signal Y1 attains an L level; however, before the scanning signal Y2 attains an H level, that is, in a period during which all the scanning signals are at an L level, the gate control signal Cntg attains an H level. Thus, in the capacitor line driving circuit 150, all the TFTs 152 enter an on state and the gate electrodes of the TFTs 158 are applied with the on voltage again, so that all the TFTs 158 enter an on state. Thus, the first to 320th capacitor lines 132 are connected to the second power supply line 166 to be applied with the voltage Vsl. Here, when the voltage Ci of the i-th capacitor line 132 is compared with that when the scanning signal Yi is at an H level, it decreases from the Vsh to the voltage Vsl by the voltage ΔV; however, the common electrode 108 is constant at the voltage LCcom. Thus, because electric charge stored in the pixel capacitor 120 moves to the storage capacitor 130, as shown in FIG. 14B, the voltage of the pixel electrode 118 decreases. Specifically, in a series connection of the pixel capacitor 120 and the storage capacitor 130, while the other terminal (common electrode) of the pixel capacitor 120 is held at a constant voltage, the other terminal of the storage capacitor 130 decreases by the voltage ΔV, so that the voltage of the pixel electrode 118 also decreases.

Thus, the voltage of the pixel electrode 118 at the point of series connection becomes Vj−{Cs/(Cs+Cpix)}·ΔV and decreases by the voltage Vj of the data signal when the scanning signal Yi is at an H level by a value that is obtained by multiplying a change in voltage ΔV of the i-th capacitor line 132 by a capacitance ratio {Cs/(Cs+Cpix)} of the pixel capacitor 120 and the storage capacitor 130. That is, as the voltage Ci of the i-th capacitor line 132 decreases by ΔV, the voltage of the pixel electrode 118 decreases by (Cs/(Cs+Cpix)}·ΔV (which is denoted as ΔVpix) from the voltage Vj of the data signal when the scanning signal Yi is at an H level. However, the parasitic capacitances of the various portions are ignored.

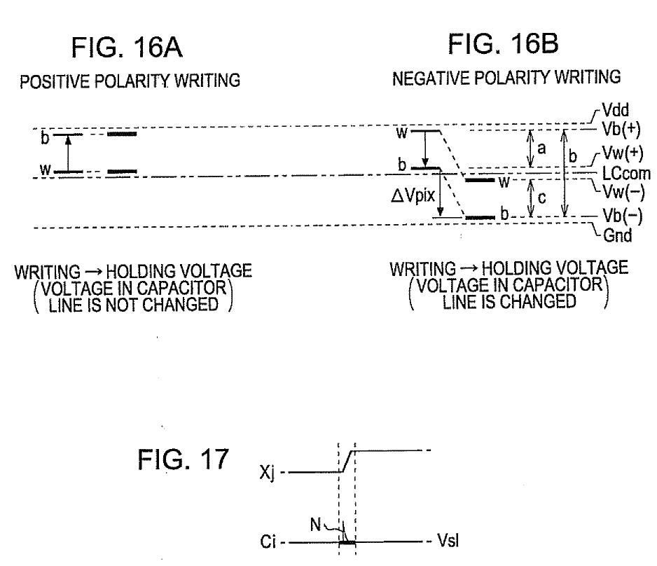

Here, in the (n+1)th frame during which negative polarity writing is specified, the data signal Xj, when the scanning signal Yi is at an H level, is set to the voltage Vj that is determined by anticipating that the pixel electrode 118 decreases by the voltage ΔVpix. That is, the decreased voltage of the pixel electrode 118 is set lower than the voltage LCcom of the common electrode 108 and makes a voltage difference between the pixel electrode 118 and the common electrode 108 correspond to a gray scale of the i-th row and j-th column pixel. Specifically, in the present embodiment, firstly, as shown in FIG. 16A, in the n-th frame during which positive polarity writing is specified, when the data signal is set in the range a from the voltage Vw(+) corresponding to white color w to the voltage Vb(+) corresponding to black color b and becomes a voltage that is higher with reference to the voltage LCcom as the gray scale decreases (darkens), as shown in FIG. 16B, in the (n+1)th frame during which negative polarity writing is specified, the data signal is set to the voltage Vb(+) when the pixel is made to appear white color w and the data signal is set to the voltage Vw(+) when the pixel is made to appear black color b. Thus, in the (n+1)th frame, the data signal is in the same voltage range a as the voltage range of positive polarity and is inverted in the gray scale relationship.

Secondly, after the voltage of the data signal is written in the (n+1)th frame, when the voltage of the pixel electrode 118 decreases by a voltage ΔVpix, the amount of decrease of the voltage ΔV (that is, the voltage Vsh or Vsl) of the capacitor line 132 is set so that the voltage of the pixel electrode 118 ranges from the voltage Vw(−) corresponding to white color of negative polarity to the voltage Vb(−) corresponding to black color and becomes symmetrical to the voltage of positive polarity with respect to the voltage LCcom. In this manner, in the (n+1)th frame during which negative polarity writing is specified, the voltage of the pixel electrode 118, when it has decreased by the voltage ΔVpix, becomes a negative polarity voltage corresponding to a gray scale, that is, a voltage that is in the range c from the voltage Vw(−) corresponding to white color w to the voltage Vb(−) corresponding to black color b and that becomes lower with respect to the voltage LCcom as the gray scale decreases (darkens). Note that, in FIG. 14A and FIG. 14B, when the i-th row and j-th column pixel capacitor 120 and storage capacitor 130 will be described, the similar operation is executed on the i-th line that shares the scanning line 112 and the capacitor line 132 in the same manner. In addition, in the (n+1)th frame, as in the case of the n-th frame, the scanning signals Y1, Y2, Y3, . . . , and Y320 sequentially attain an H level, so that the operation in each line is sequentially executed on the first, second, third, . . . , and 320th row pixels.

In this manner, in the present embodiment, the range a of a voltage applied to each of the data lines in the (n+1)th frame during which negative polarity writing is specified is the same as in the n-th frame during which positive polarity writing is specified; however, the voltage of each of the pixel electrodes 118, after being shifted, becomes a negative polarity voltage corresponding to a gray scale. In this manner, according to the present embodiment, because not only the withstand voltages of the elements that constitute the data line driving circuit 190 may be narrow but also the amplitude of a voltage applied to each of the data lines 114 that have a parasitic capacitance becomes narrow, wasteful power consumption by the parasitic capacitances does not occur. Note that the voltage range of the data signal when positive polarity writing is specified is set to coincide with the voltage range of the data signal when negative polarity writing is specified however, even when they do not completely coincide with each other, it is possible to suppress the voltage amplitude of the data signals by a variation in voltage of the capacitor line 132.

When the voltage range a in positive polarity writing and negative polarity writing of the present embodiment is described in comparison with the existing configuration, in the existing configuration, the common electrode 108 is held at the voltage LCcom, while the voltages of the capacitor lines 132 are held constant over each frame. In this configuration, in the case where each of the pixel capacitors 120 is driven with alternating current, when the pixel electrode 118 is applied with a voltage that ranges from the positive polarity voltage Vw(+) to the positive polarity voltage Vb(+) in accordance with a gray scale in a certain frame, it is necessary, when the gray scale remains unchanged, to apply a voltage that ranges from the voltage Vw(−) to the voltage Vb(−) corresponding to negative polarity and that is inverted with reference to the voltage LCcom in the next frame. Thus, in the configuration in which the voltage of the common electrode 108 is constant, when the voltage of each capacitor line 132 is held constant, the voltage of the data signal falls within the range b shown in FIG. 16B. For this reason, the withstand voltages of the elements that constitute the data line driving circuit 190 also need to support the range b. Furthermore, as the voltage varies within the wide range b in the data line 114 that have a parasitic capacitance, wasteful power consumption due to the parasitic capacitance occurs. In contrast, in the present embodiment, the voltage range within which the data signals supplied to the data lines 114 fall in positive polarity writing and negative polarity writing is the range a that is narrower than the range b. Thus, not only the withstand voltages of the elements that constitute the data line driving circuit 190 may be narrow but also it is possible to suppress power consumed by the parasitic capacitances of the data lines 114.

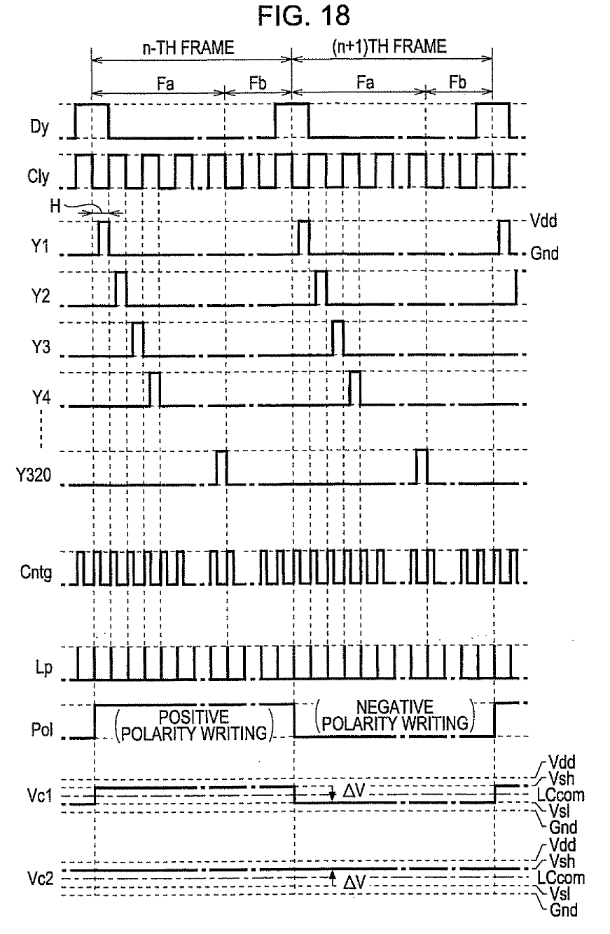

In addition, according to the present embodiment, when the scanning signal Yi is at an H level, the i-th capacitor line 132 is connected to the first power supply line 165 in such a manner that the i-th TFT 156 enters an on state, and the gate electrode of the i-th TFT 158 is maintained at the on voltage Von owing to its parasitic capacitance in such a manner that the gate control signal Cntg is at an H level after the scanning signal Yi shifts from an H level to an L level, so that the TFT 158 continues to be in an on state. Thus, the i-th capacitor line 132 never enters a state (high impedance state) of not being electrically connected to any portions. This point will be specifically described. If the capacitor line 132 is in a high impedance state when the data signal changes in voltage, noise, or the like, in accordance with the amount of variation in voltage of the data signal and its direction is superposed and, as a result, the capacitor line 132 varies from the Vsl. For example, when the voltage of the data signal Xj supplied to the j-th data line 114 is increased in order to write voltages to the next (i+1)th row pixels after writing of the voltages to the i-th row pixel capacitors has finished, and when the i-th capacitor line 132 is in a high impedance state, as shown in FIG. 17, the voltage Ci of the capacitor line 132 is superposed with spike noise N corresponding to the increase in voltage. Here, as the i-th capacitor line 132 varies from the voltage Vsl, movement of electric charge occurs and then the voltages corresponding to the gray scales cannot be held in the i-th row pixel capacitors 120. As a result, the display quality decreases. In contrast, in the present embodiment, the gate electrode of the TFT 158 is periodically applied with the on voltage by setting the gate control signal Cntg to an H level at the timing at which a selection voltage is applied to the scanning line 112, and each of the capacitor lines 132 is connected to the second power supply line 166 to thereby avoid making each capacitor line 132 enter a high impedance state. Thus, all the capacitor lines 132 are not only hardly influenced by a variation in the voltage of the data line 114 but also hardly influenced by a variation in the voltage of the scanning line. Thus, according to the present embodiment, a decrease in display quality due to a variation in electric potential of each capacitor line 132 may be suppressed.

In the above description, the scanning lines 112 are sequentially scanned in the order of the first, second, third, . . . , and 320th lines; however, in recent years, there is a possibility that the display area 100 is pivoted and scanning the scanning lines 112 in the reverse order of the 320th, 319th, 318th, . . . , and the first lines may possibly be required. In the present embodiment, the i-th TFTs 154 and 156 are made to enter an on state or an off state using the scanning signal Yi; however, the i-th TFT 152 is made to enter an on state or an off state using the gate control signal Cntg that is irrelevant to the scanning direction of the scanning signals, so that it is only necessary to just invert the output order of the scanning signals. In addition, in the present embodiment, only four TFTs 152, 154, 156 and 158 are enough for driving the one capacitor line 132 Thus, it is possible to avoid a complex capacitor line driving circuit 150 that drives the capacitor line 132 corresponding to each line.

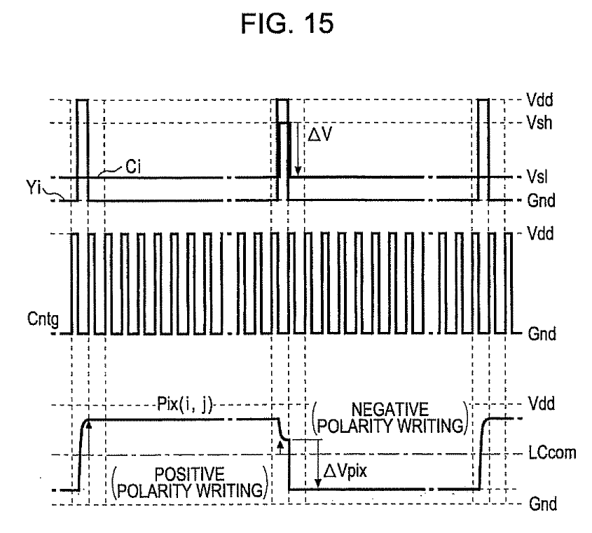

Note that FIG. 15 is a view that shows the voltage relationship among the scanning signal, the capacitor line and the pixel electrode, showing a variation in voltage of the i-th row and j-th column pixel electrode 118 using Pix(i, j). In the drawing, the i-th capacitor line 132, when the scanning signal Yi is at an H level, is connected to the first power supply line 165 and thereby the voltage Ci of the i-th capacitor line 132 becomes the voltage of the first capacitive signal Vc1. When the gate control signal Cntg is at an H level, the on voltage Von is applied and held with the gate electrode of the i-th TFT 158, so that the i-th capacitor line 132 is connected to the second power supply line 166 and thereby the voltage Ci of the i-th capacitor line 132 is held at the voltage of the second capacitive signal Vc2. Thus, the voltage Ci is determined to be the voltage Vsl after the scanning signal Yi shifts from an H level to an L level. In addition, at the time when the scanning signal Yi is at an H level, the voltage Ci is determined to be the voltage Vsl when positive polarity writing is specified and is determined to be the voltage Vsh when negative polarity writing is specified.

### First Application and Modification of Third Embodiment

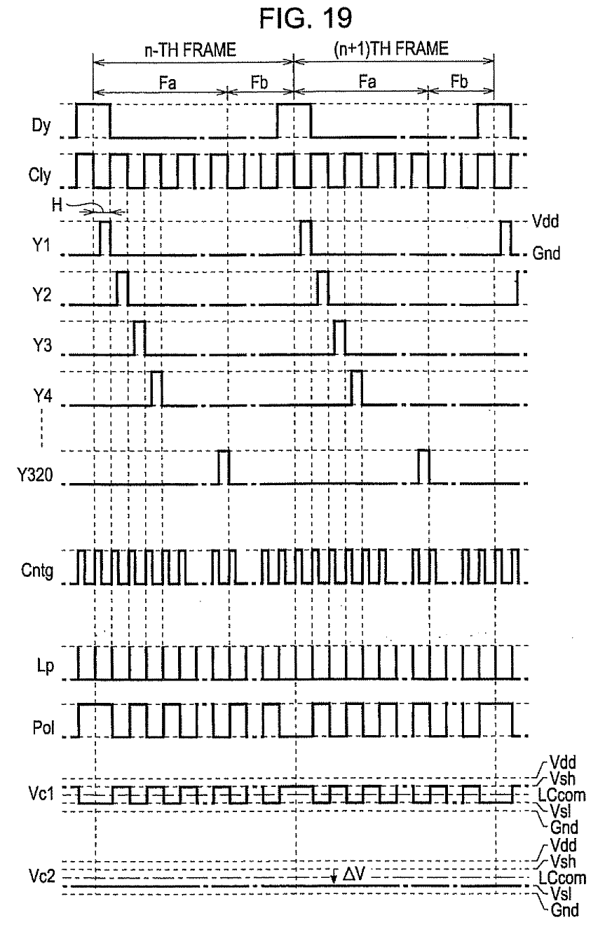

Note that, in this description, by holding the second capacitive signal Vc2 constant at the voltage Vsl, the voltage of the i-th capacitor line 132 is made unchanged in the n-th frame during which positive polarity writing is specified, while the voltage of the i-th capacitor line 132 is decreased by the voltage ΔV in the (n+1)th frame during which negative polarity writing is specified. Thus, the voltage of the pixel electrode 118, which has been written when the scanning signal Yi was at an H level, is decreased by the voltage ΔVpix. However, the configuration may be opposite to this. That is, as shown in FIG. 18, it is applicable that, by holding the second capacitive signal Vc2 constant at the voltage Vsh, the voltage of the i-th capacitor line 132 is made unchanged in a frame during which negative polarity is specified, while the voltage of the i-th capacitor line is increased by the voltage ΔV in a frame during which positive polarity writing is specified, and then the voltage of the pixel electrode 118, which has been written when the scanning signal Yi was at an H level, is increased by the voltage ΔVpix. In the above configuration, the relationship in the voltage of the data signal is obtained by inverting the ones shown in FIG. 16A and FIG. 16B with respect to the voltage LCcom, and it is only necessary that positive polarity is read as negative polarity and negative polarity is read as positive polarity.

### Second Application and Modification of Third Embodiment

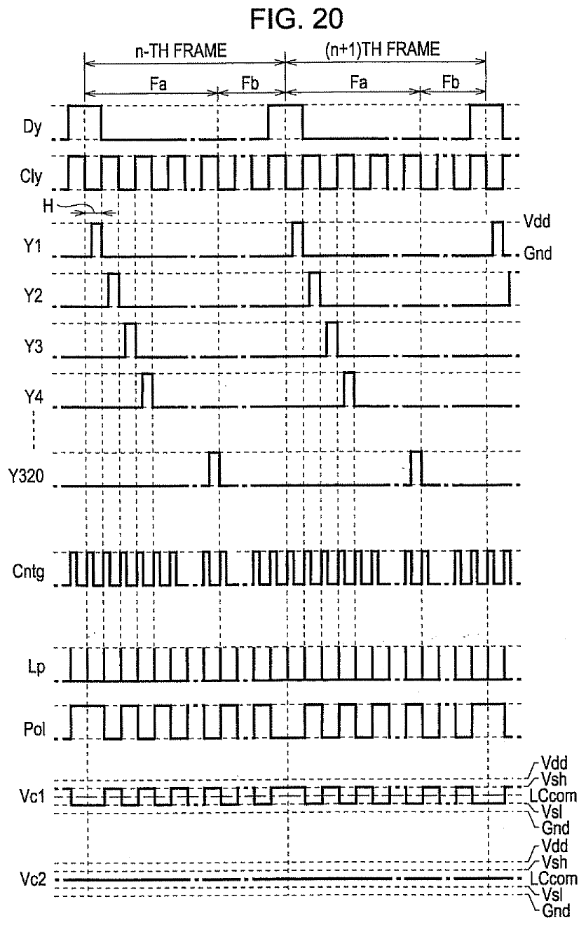

Furthermore, in this description, all the polarities written to the pixels in a period of one frame are uniform, and a surface in version mode in which the writing polarity is inverted once in every period of one frame; however, a scanning line inversion mode or a line inversion mode in which the writing polarity is inverted once in every line may be applied. In the case of scanning line inversion mode, the polarity specifying signal Pol, as shown in FIG. 19, is inverted once in every horizontal scanning period (H). When, between any adjacent frames, when a period during which the same scanning signal is at an H level (the same scanning line is selected) is focused, the polarity specifying signals Pol are inverted relative to each other. Furthermore, the first capacitive signal Vc1 becomes the voltage Vsl when the polarity specifying signal Pol is at an H level, and becomes the voltage Vsh when the polarity specifying signal Pol is at an L level. In this manner, in the n-th frame shown in FIG. 19, the odd-numbered (first, third, fifth, . . . , and 319th) capacitor lines 132 do not change in voltage even when the scanning signals supplied to the respective lines shift from an H level to an L level and the gate control signal Cntg attains an H level; however, the even-numbered (second, fourth, sixth, . . . , and 320th) capacitor lines 132 decrease by the voltage ΔV when the scanning signals supplied to the respective lines shift from an H level to an L level and the gate control signal Cntg attains an H level. Thus, in the n-th frame shown in FIG. 19, the same positive polarity writing as that shown in FIG. 16A is executed in each of the odd-numbered lines, while the same negative polarity writing as that shown in FIG. 16B is executed in each of the even-numbered lines. On the other hand, in the (n+1)th frame shown in FIG. 19, the odd-numbered capacitor lines 132 decrease by the voltage ΔV when the scanning signals supplied to the respective lines shift from an H level to an L level and the gate control signal Cntg attains an H level; however, the even-numbered capacitor lines 132 do not change in voltage even when the scanning signals supplied to the respective lines shift from an H level to an L level and the gate control signal Cntg attains an H level. Thus, in the (n+1)th frame shown in FIG. 19, the same negative polarity writing as that shown in FIG. 16B is executed in each of the odd-numbered lines, while the same positive polarity writing as that shown in FIG. 16A is executed in each of the even-numbered lines. Note that, in FIG. 19, the second capacitive signal Vc2 is set to the voltage Vsl; however, it is also applicable that the second capacitive signal Vc2 is set to the voltage Vsh and then the voltage of the capacitor line 132 is increased by ΔV.

### Third Application and Modification of Third Embodiment

In addition, when the scanning line inversion mode is employed as described above, as shown in FIG. 20r it is applicable that the second capacitive signal Vc2 is constant at the voltage LCcom. When the second capacitive signal Vc2 is constant at the voltage LCcom, in the n-th frame shown in FIG. 20, the odd-numbered capacitor lines 132 increase from the voltage Vsl to the voltage LCcom when the scanning signals supplied to the respective lines shift from an H level to an L level and the gate control signal Cntg attains an H level, and the even-numbered capacitor lines 132 decrease from the voltage Vsh to the voltage LCcom when the scanning signals supplied to the respective lines shift from an H level to an L level and the gate control signal Cntg attains an H level, while, on the other hand, in the (n+1)th frame, the odd-numbered capacitor lines 132 decrease from the voltage Vsh to the voltage LCcom when the scanning signals supplied to the respective lines shift from an H level to an L level and the gate control signal Cntg attains an H level, and the even-numbered capacitor lines 132 increase from the voltage Vsl to the voltage LCcom when the scanning signals supplied to the respective lines shift from an H level to an L level and the gate control signal Cntg attains an H level. Here, where the amount of increase (LCcom−Vs1) from the voltage Vsl to the voltage LCcom and the amount of decrease (Vsh−LCcom) from the voltage Vsh to the voltage LCcom each are equally set to ΔV, that is, set so that the voltage ΔV=LCcom−Vsl=Vsh−LCcom, the voltage of the i-th capacitor line 132 changes by the voltage ΔV from time when the scanning signal Yi was at an H level to time when the scanning signal Yi attains an L level and the gate control signal Cntg attains an H level. Thus, in this example, Vsh−Vsl is equal to 2ΔV, and the middle of these two voltages Vsh and Vsl is the voltage of the second capacitive signal Vc2 and is the voltage LCcom applied to the common electrode 108.

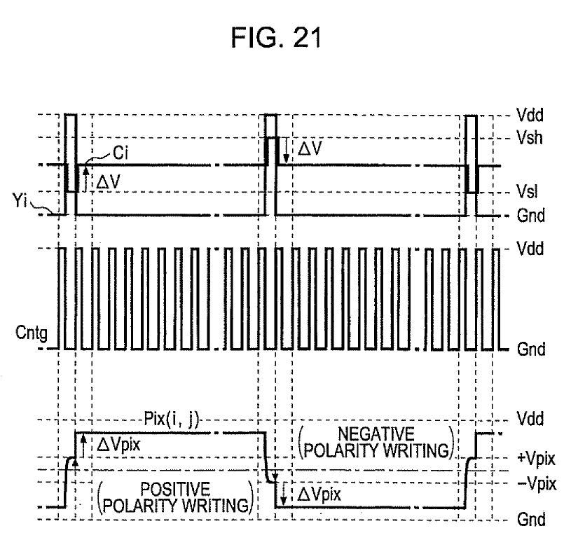

Note that FIG. 21 is a view that shows the voltage relationship among the scanning signal, the capacitor line and the pixel electrode, showing a variation in voltage of the i-th row and j-th column pixel electrode 118 using Pix(i, j). In the drawing, when the positive polarity writing is specified, the voltage Ci of the i-th capacitor line 132 becomes the voltage Vsl when the scanning signal Yi attains an H level and, when the scanning signal Yi shifts from an H level to an L level and the gate control signal Cntg attains an H level, becomes the voltage LCcom to thereby increase by the voltage ΔV, while, on the other hand, when negative polarity writing is specified, the voltage Ci of the i-th capacitor line 132 becomes the voltage Vsh when the scanning signal Yi attains an H level and, when the scanning signal Yi shifts from an H level to an L level and the gate control signal Cntg attains an H level, becomes the voltage LCcom to thereby decrease by the voltage ΔV. Note that the voltage Ci, after the scanning signal Yi shifts from an H level to an L level, is connected to the second power supply line 166 and determined to be the voltage Vsl which is the same as that shown in FIG. 15.

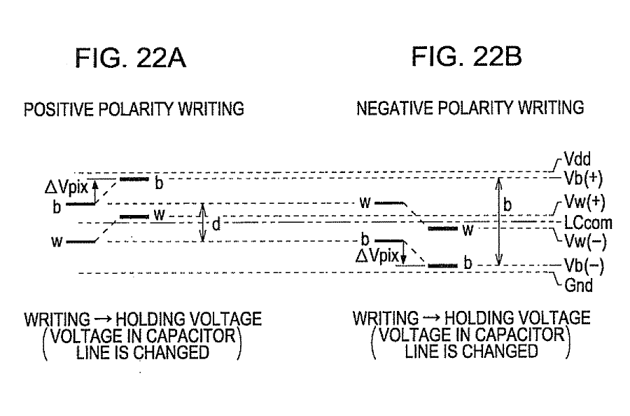

As the capacitor line 132 increases or decreases by the voltage ΔV, the corresponding pixel electrodes 118 also increase or decrease by the voltage ΔVpix. Thus, the voltage of the data signal Xj, when the scanning signal attains an H level, is set to a voltage that is determined by anticipating a variation, that is, the voltage ΔVpix. Specifically, when positive polarity writing is specified, as shown in FIG. 22A, because of the increase in the voltage ΔVpix, it is only necessary to shift from the voltage LCcom to the voltage that is spaced apart by a voltage corresponding to a gray scale within the range from the voltage Vw(+) to the voltage Vb(+), so that the voltage of each data signal may be set to a voltage range that is, the other way round, decreased by the voltage ΔPix from the range of the voltage Vw(+) to the voltage Vb(+). On the other hand, when negative polarity writing is specified, as shown in FIG. 22B, because of the decrease in the voltage ΔVpix, it is only necessary to shift from the voltage LCcom to the voltage that is spaced apart by a voltage corresponding to a gray scale within the range from the voltage Vw(−) to the voltage Vb(−), so that the voltage of each data signal may be set to a voltage range that is increased by the voltage ΔPix reversely from the range of the voltage Vw(−) to the voltage Vb(−). At this time, when the voltage ΔV is set (voltage Vsh or Vsl) so that the voltage range of the data signal when positive polarity writing is specified is set to coincide in a range d with the voltage range of the data signal when negative polarity writing is specified, it is possible to suppress the voltage amplitude of the data signals to a minimum degree. Note that the voltage range a shown in FIG. 22A and FIG. 22B, in a normally white mode, is set so that a white color w side is lower and a black color b side is higher when positive polarity writing is specified, but the voltage range a is set so that a white color w side is higher and a black color b side is lower when negative polarity writing is specified and, therefore, the gray scale relationship is inverted.

### Fourth Application and modification of Third Embodiment

In the i-th line of the above capacitor line driving circuit 150, the period during which the TFTs 154 and 156 are in an on state is a period during which the scanning signal Yi is at an H level, and the period during which the TFT 152 is in an on state is a period during which the gate control signal Cntg is at an H level, while the period during which the i-th TFT 158 is in an on state is substantially all over a non-selection period of the i-th line (a period during which the scanning signal Yi is at an L level). Thus, the TFT 158 needs to be in an on state for extremely long period of time in comparison with the TFT 152, 154 or 156, so that the transistor characteristic tends to degrade. Note that the degradation of the transistor characteristic mentioned herein means that the gate voltage (threshold voltage) for entering an on state as a switch increases over time. Thus, as the TFT 158 is used for a long period of time, the possibility of malfunction that the TFT 158 does not enter an on state in a non-selection period increases. Then, an application example that suppresses the possibility of such malfunction to a lesser degree will be described.

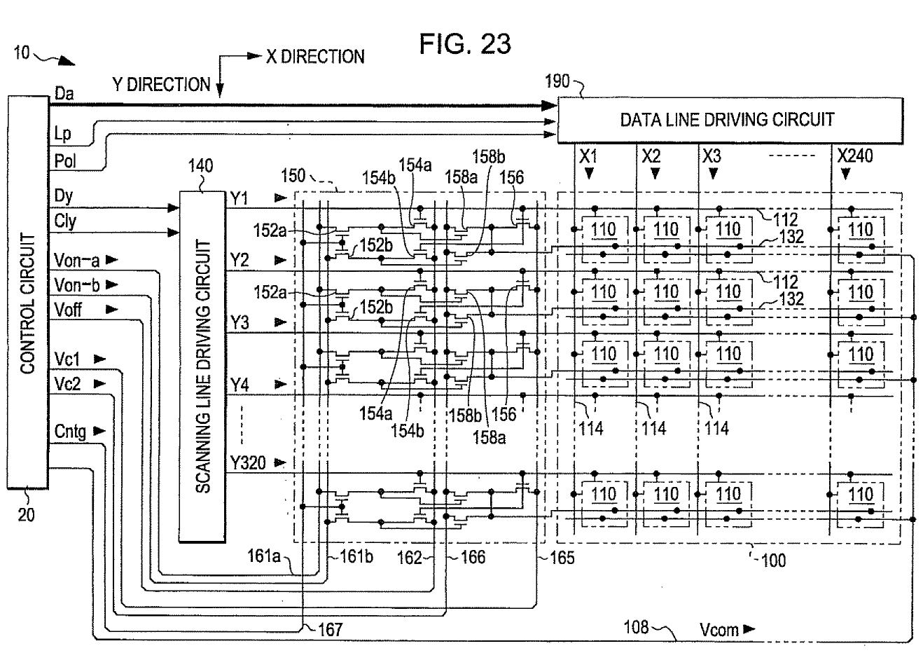

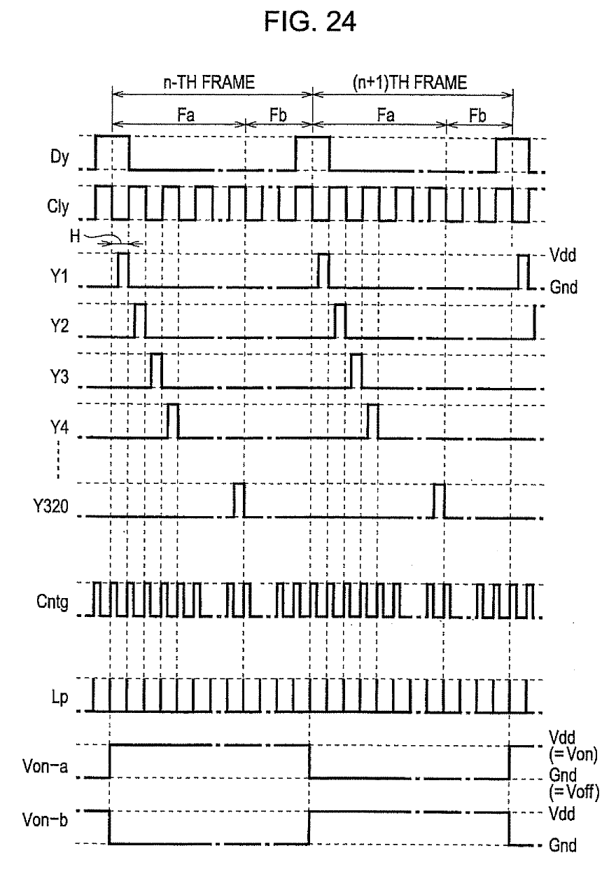

FIG. 23 is a block diagram that shows the configuration of an electro-optical device according to this application example. As shown in the drawing, in the application example, each of the TFTs 158 is divided into two lines, that is, TFTs 158a and 158b, and they are alternately used. Specifically, in the capacitor line driving circuit 150 according to the application example, each of the TFTs 158 is divided into an a line and a b line in each line. The a line includes TFTs 152a, 154a and 158a, and the source electrode of the TFT 152a is connected to a first on voltage supply line 161a. In addition, the b line includes TFTs 152b, 154b and 158b, and the source electrode of the TFT 152b is connected to a second on voltage supply line 161b. In this application example, the control circuit 20 supplies a signal Von-a to the first on voltage supply line 161a and supplies a signal Von-b to the second on voltage supply line 161b. One example of the voltage waveform of these signals Von-a and Von-b may be, for example, shown in FIG. 24, in which, in the n-th frame, the signal Von-a is at the on voltage Von and the signal Von-b is at the off voltage Voff, and, in the next (n+1)th frame, the signal von-a is at the off voltage Voff and the signal Von-b is at the on voltage Von.

In this example, when the scanning signal Yi shifts from an H level to an L level and the gate control signal Cntg attains an H level, the transistor that connects the i-th capacitor line 132 to the second power supply line 166 is the TFT 158a in the n-th frame during which the signal Von-a is at the on voltage Von and is the TFT 158b in the (n+1)th frame during which the signal Von-b is at the on voltage Von. Thus, according to the application example, the period during which any one of the TFTs 158a and 158b is in an on state is half in comparison with the TFT 158 in the third embodiment, so that it is possible to suppress the possibility of malfunction due to long-term usage to a lesser degree. Note that this application example may be applied to any one of FIG. 13, FIG. 18, FIG. 19 or FIG. 20 as the first capacitive signal Vc1, the second capacitive signal Vc2 and the polarity specifying signal Pol.

In addition, in this application example, the on voltage supply line 161 in the third embodiment is divided into the first on voltage supply line 161a and the second on voltage supply line 161b, and the source electrode of the TFT 152a is connected to the first on voltage supply line 161a and the source electrode of the TFT 152b is connected to the second on voltage supply line 161b; however, it is applicable that the gate control signal Cntg is divided into two lines, and the gate electrode of the TFT 152a is supplied with the gate control signal Cntg of one of the lines and the gate electrode of the TFT 152b is supplied with the gate control signal Cntg of the other line. In addition, in this application example, in the non-selection period, the transistor that connects the capacitor line 132 to the second power supply line 166 is switched between the TFTs 158a and 158b once in every period of one frame, but it is not limited to this configuration. Furthermore, the TFTs 158a and 158b need not be switched periodically, but they may be switched every time power is turned on (or shut down), for example. In this application example, the configuration in which the TFT 158 is divided into two TFTs 158a and 158b is described; however, it is applicable that the TFT 158 is divided into three or more TFTs and they are used by switching in a predetermined order. That is, the application example is intended to reduce degradation of the transistor characteristic by reducing a period during which any one of the TFTs 158 is in an on state (by increasing a period during which any one of the TFTs 158 is in an off state), so that it is applicable that, in a non-selection period, among the plurality of TFTs 158, at least one TFT 158 is in an off state and at least one TFT 158 is in an on state, and then the at least one TFT 158 that is in an on state is switched in a predetermined order.

### Fourth Embodiment

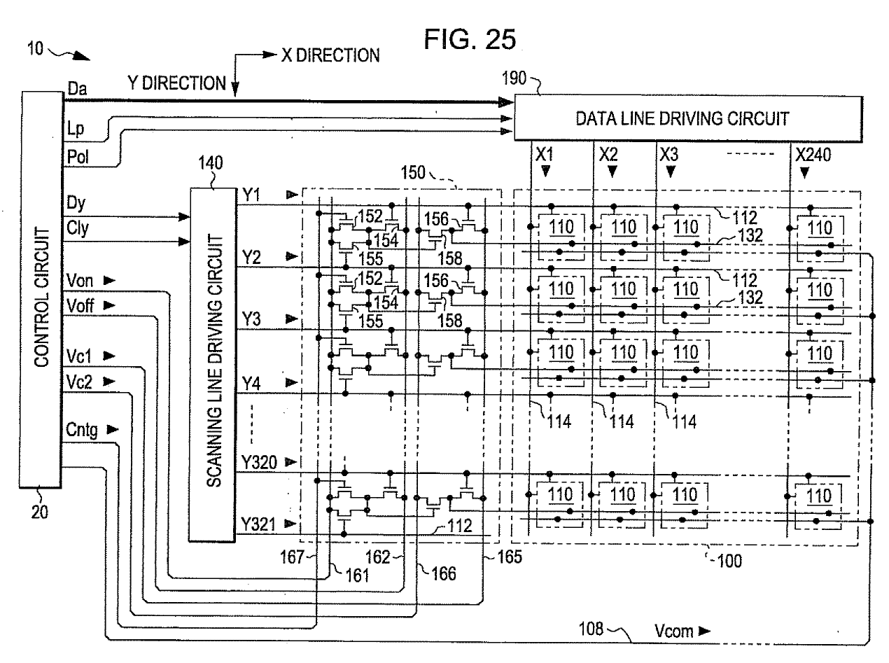

Next, a fourth embodiment according to the invention will be described. FIG. 25 is a block diagram that shows the configuration of an electro-optical device according to the fourth embodiment. The configuration shown in the drawing differs from that of the third embodiment (see FIG. 10) in that a TFT (fifth transistor) is provided in each line of the capacitor line driving circuit 150. Then, this point will be specifically described. The TFTs 155 in the capacitor line driving circuit 150 are provided in correspondence with the first to 320th capacitor lines 132. Here, when a description will be made using the i-th line, the gate electrode of the TFT 155 is connected to the next (i+1)th scanning line 112, the source electrode thereof is connected to the on voltage supply line 161, and the drain electrode thereof, together with the drain electrodes of the i-th TFTs 152 and 154, is connected to the gate electrode of the i-th TFT 158. Note that, in the fourth embodiment, in order to support the 320th line, which is the last row of the pixel array, the 321st scanning line 112 is provided as a dummy, and the scanning line driving circuit 140 supplies the scanning signal Y321 to this dummy scanning line 112.

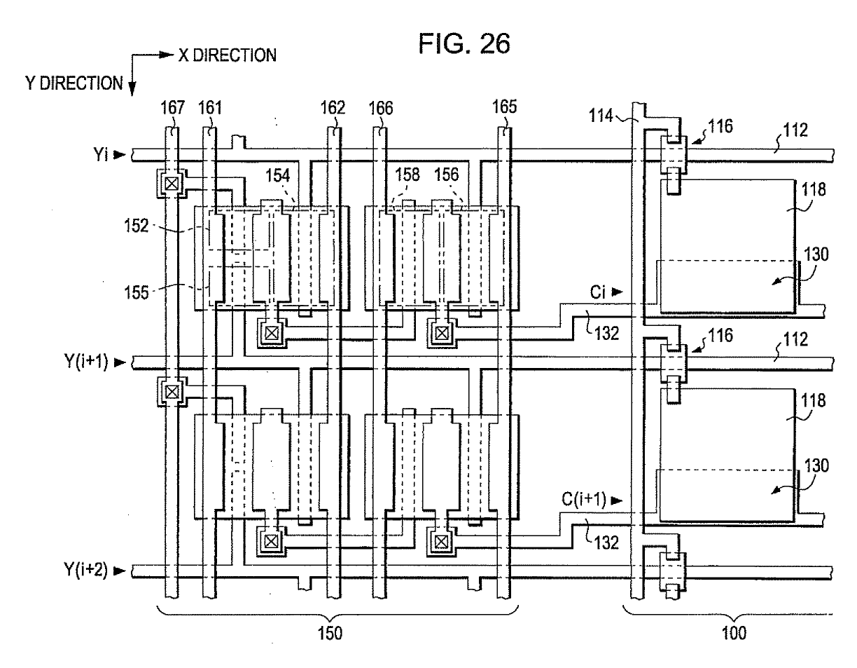

FIG. 26 is a plan view that shows the configuration around the boundary between the capacitor line driving circuit 150 and the display area 100 within the element substrate in the fourth embodiment. The portions shown in the drawing differs from those of the third embodiment (see FIG. 12) in that the TFT 152 is relocated upward in the drawing and the TFT 155 is provided in a region that is unoccupied because of the relocation. The gate electrode of the i-th TFT 155 is a portion that branches from the (i+1)th scanning line 112 in a Y (upward) direction in a T shape. In addition, the common drain electrode of the TFTs 152, 154 and 155 is connected to the gate electrode of the TFT 158 through a contact hole. Note that, in FIG. 26, where the transistor size of the TFT 155 is represented as Tr5, the sizes of them are set so that Tr2=Tr3=Tr4>Tr1=Tr5; however, as will be described later, because it is desirable that the on resistance of the TFT 156 is smaller, the sizes may be set so that Tr3≧Tr4≧Tr1=Tr2=Tr5.

In the capacitor line driving circuit 150 according to the fourth embodiment, the on voltage Von is applied to the gate electrode of the TFT 158 in each line when the gate control signal Cntg is at an H level or when the next scanning signal is at an H level. Here, because the scanning signal attains an H level and, after that, the next scanning signal attains an H level, that is, taking the i-th line for instance, the scanning signal Yi attains an H level and, after that, the next scanning signal (i+1) attains an H level. Thus, according to the fourth embodiment, even when no gate control signal Cntg is specifically supplied, it is possible to determine the voltage of the capacitor line 132 to the voltage of the second capacitive signal Vc2 in such a manner that the gate electrode of the TFT 158 is made to hold the on voltage Von and then the on state of the TFT 158 is maintained.

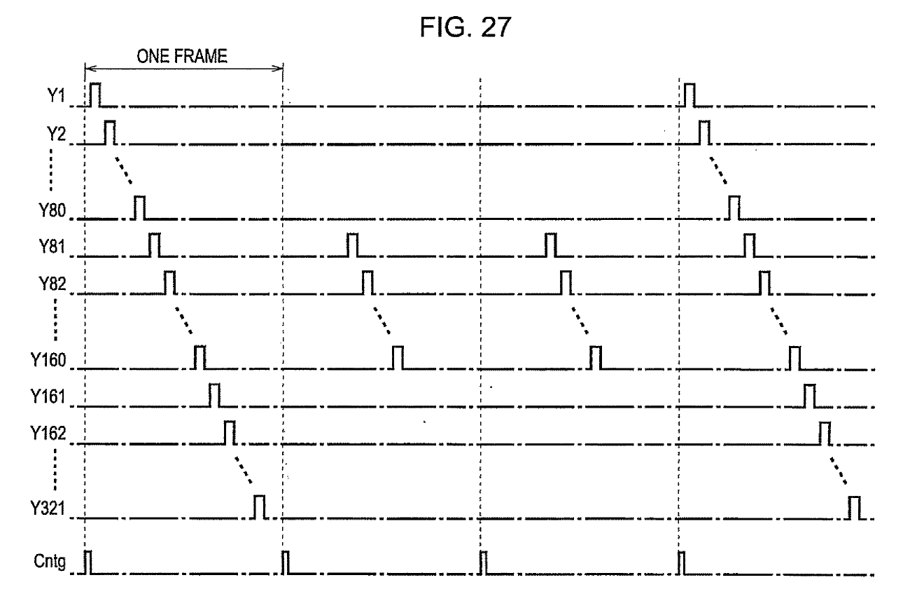

Incidentally, in recent years, in addition to a mode (full-screen display mode) in which display is performed using all the pixels, a mode (partial display mode) in which display, such as time or an icon, is performed using only pixels in a portion of the rows and the other pixels are turned off may be used by switching between the modes appropriately in accordance with an operating state. In the partial display mode, the scanning lines used for display are supplied with the same scanning signals as the full-screen display mode, so that the cycle at which the scanning signal attains an H level remains unchanged. However, in regard to the scanning lines that are not used for display (set as non-display), only an off level (a white color display voltage in the normally white mode) is written to each of the pixels, so that the cycle at which the scanning signal attains an H level is extremely longer than that of the full-screen display mode. For example, in the partial display mode in which, among the first to 320th lines, the 81st to 160th row pixels are used for display and the other row pixels are not used for display, among the scanning signals Y1 to Y321, as shown in FIG. 27, the scanning signals Y81 to Y160 sequentially attain an H level once in every period of one frame, but the scanning signals Y1 to Y80 and Y161 to Y321 attain an H level only once in every period of a plurality of frames.

Thus, in the configuration shown in FIG. 25, when the configuration in which no gate control signal Cntg is supplied in the partial display mode is assumed, the interval at which the on voltage Von is applied to the gate electrode of the TFT 158 in each line that is not used for display becomes long and, thereby, the on voltage Von cannot be maintained because of leakage of the gate electrode. When the on voltage Von cannot be maintained in the gate electrode, the TFT 158 enters an off state. Thus, the capacitor line 132 enters a high impedance state and, as a result, leads to a decrease in display quality due to a variation in voltage. Note that, when a capacitance is actively added to the gate electrode of each TFT 158, the influence due to the leakage may be suppressed; however, if a capacitance is added, there is a problem that the window frame becomes wide by that much.

Then, in the case of partial display mode, as shown in FIG. 27, by supplying the gate control signal Cntg that periodically attains an H level in a period during which any one of the scanning signals is at an L level, even when the cycle at which the next scanning signal Y(i+1) attains an H level becomes long, the gate electrode of the i-th TFT 158 may be held at the on voltage Von without adding a capacitance.

Note that, in the example of the gate control signal Cntg shown in FIG. 27, the gate control signal Cntg attains an H level once in every period of one frame; however, it is only necessary that the gate control signal Cntg periodically attains an H level in a period during which all the scanning signals are at an L level. Thus, in the example of the gate control signal Cntg, including the third embodiment, in a period during which all the scanning signals Y1 to Y320 are at an L level, it is applicable that the gate control signal Cntg attains an H level once every time, for example, two scanning lines are selected.

### Fifth Embodiment

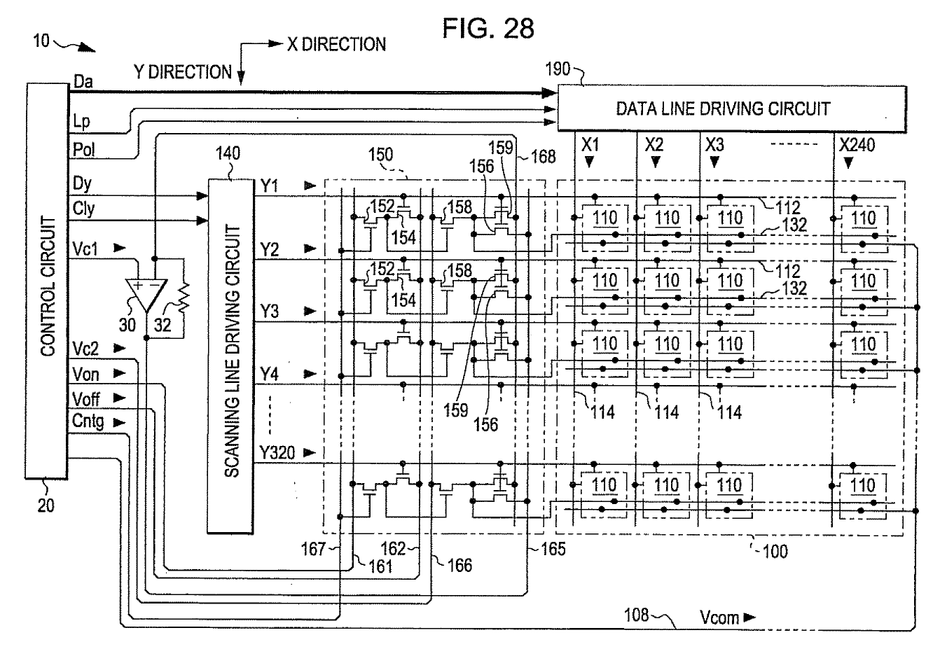

Next, a fifth embodiment according to the invention will be described. FIG. 28 is a block diagram that shows the configuration of an electro-optical device according to the fifth embodiment of the invention. The configuration shown in the drawing differs from that of the third embodiment (see FIG. 10) in that a TFT 159 (sixth transistor) is further provided in each line of the capacitor line driving circuit 150, and a detection line 168, an operational amplifier 30 and a resistance element 32 are provided.

Then, this point will be specifically described. The TFTs 159 in the capacitor line driving circuit 150 are provided in correspondence with the first to 320th capacitor lines 132. Here, when a description will be made using the i-th TFT 159, the gate electrode there of is connected to the i-th scanning line 112, the source electrode thereof is connected to the i-th capacitor line 132 (that is, the common electrode of the i-th TFTs 156 and 158), and the drain electrode thereof is connected to the detection line 168. On the other hand, in the fifth embodiment, the first capacitive signal Vc1 from the control circuit 20 is supplied to the non-inverting input terminal (+) of the operational amplifier 30, and the detection line 168 is connected to the inverting input terminal (−−) of the operational amplifier 30. The output signal generated by the operational amplifier 30 is supplied to the first power supply line 165 and is also returned to the inverting input terminal (−) of the operational amplifier 30 through the resistance element 32.

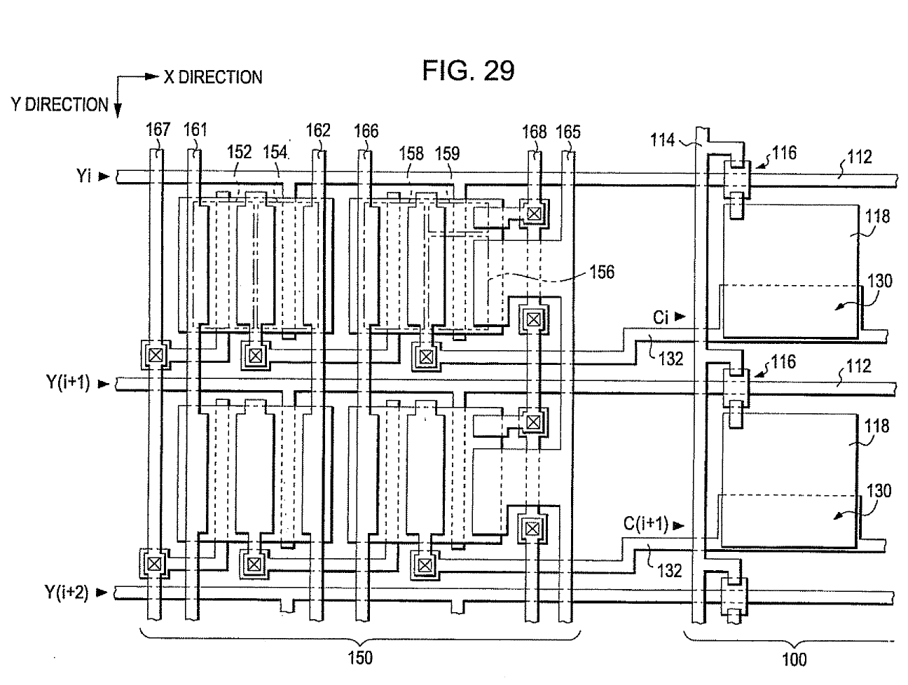

FIG. 29 is a plan view that shows the configuration around the boundary between the capacitor line driving circuit 150 and the display area 100 within the element substrate in the fifth embodiment. The portions shown in the drawing differ from those of the third embodiment (see FIG. 12) in that the detection line 168 is provided adjacent to the TFTs 156 and 158 relative to the first power supply line 165 so as to extend in a Y direction in parallel to the first power supply line 165 and, furthermore, the TFT 159 is provided in each line. Here, the gate electrode of the TFT 159 is a portion that is branched from the scanning line 112 in the Y (downward) direction in a T shape and is also used as the gate electrode of the TFT 156. In addition, the source electrode of the TFT 156 is a wide portion that extends to be branched from the first power supply line 165 and that overlies the detection line 168. The portion of the detection line 168 that overlies the scanning lines 112 and the capacitor lines 132, which are formed of the gate electrode layer, is formed of the third conductive layer, as well as the first power supply line 165; however, the portion of the detection line 168 that intersects the source electrode (the wide portion of the first power supply line 165) of the TFT 156 is formed of the gate electrode layer. Thus, the detection line 168 is provided with two contact holes in each line and extends in the Y direction while achieving electrical conduction alternately by the portion of line formed of the third conductive layer and the portion of line formed of the gate electrode layer.

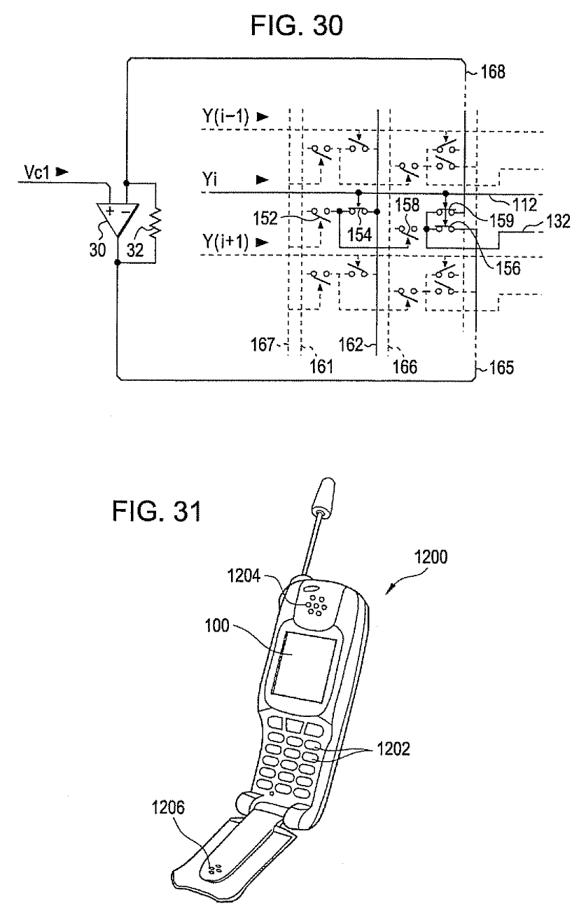

In the electro-optical device 10 according to the fifth embodiment, the operation, when the i-th scanning signal Yi is at an H level, will be described. FIG. 30 is a view that shows an equivalent circuit of the capacitor line driving circuit 150 when the scanning signal Yi is at an H level. As the scanning signal Yi attains an H level, as shown in the drawing, the i-th TFTs 154, 156 and 159 enter an on state in the capacitor line driving circuit 150. As the i-th TFT 154 enters an on state, the gate electrode of the TFT 158 is connected to the off voltage supply line 162, so that the i-th TFT 158 enters an off state. In addition, as the i-th TFTs 156 and 159 enter an on state, the first power supply line 165, to which the output signal of the operational amplifier 30 is supplied, is connected to the i-th capacitor line 132, while only the i-th capacitor line 132 is connected to the detection line 168.

Thus, the operational amplifier 30 executes the following operation. That is, the operational amplifier 30 increases the voltage of the output terminal when the voltage of the i-th capacitor line 132, detected through the detection line 168, is lower than the voltage of the first capacitive signal Vc1 supplied to the non-inverting input terminal (+), while, on the other hand, the operational amplifier 30 decreases the voltage of the output terminal when the voltage of the i-th capacitor line 132 is higher than the voltage of the first capacitive signal Vc1. Thus, according to the fifth embodiment, when the scanning signal Yi is at an H level, the voltage applied to the i-th capacitor line 132 consequently balances at a voltage that coincides with the voltage of the first capacitive signal Vc1. The above operation will be executed for the first, second, third, . . . , and 320th capacitor lines 132 when the scanning signals Y1, Y2, Y3, . . . , and Y320 attain an H level, respectively.

Note that the operation other than the operation, when the scanning signal attains an H level and the capacitor line 132 is then connected to the first power supply line 165, is the same as that of the third embodiment In addition, when the gate control signal Cntg is at an H level, that is, all the scanning signals are also at an L level, the detection line 168 is not connected to any one of the capacitor lines 132, so that the operational amplifier 30 functions as a buffer circuit of voltage amplification “+1”.

If the i-th capacitor line 132 cannot be applied with the voltage Vsl or Vsh when the TFT 156 enters an on state because of lack of ability of the TFT 156, a given voltage that has not shifted yet is inaccurate and, therefore, there is a possibility that the display quality is impaired. In contrast, according to the fifth embodiment, because, when the scanning signal Yi attains an H level, the i-th capacitor line 132 may be accurately applied with the voltage of the first capacitive signal Vc1 by the feedback control of the operational amplifier 30, the display quality is not impaired.

In addition, according to the fifth embodiment, even when the on resistance of the TFT 156 is large, because, when the scanning signal Yi attains an H level, the i-th capacitor line 132 may be accurately applied with the voltage of the first capacitive signal Vc1 by the feedback control of the operational amplifier 30, a large transistor size is not required of the TFT 156. Thus, in the third embodiment, space required for the capacitor line driving circuit 150 is reduced and, as a result, a so-called window frame located outside the display area may be narrowed. Furthermore, even when there is a variation among the on resistances of the first to 320th TFTs 156, because, the voltage of the first capacitive signal Vc1 may be equally applied over each of the first to 320th capacitor lines 132 when the corresponding scanning signal attains an H level, it is possible to suppress the occurrence of display chrominance non-uniformity, or the like, due to uneven voltages that have not yet shifted.

### Application and Modification

In the embodiments, the pixel electrodes 118 and the common electrode 108, which serve as the pixel capacitors 120, hold the liquid crystal 105 to thereby make the direction of an electric field applied to the liquid crystal in a vertical direction of the substrate plane; however, the aspects of the invention may also be applied to the configuration in which pixel electrodes, an insulating layer and a common electrode are laminated to make the direction of an electric field applied to the liquid crystal be in a horizontal direction of the substrate plane, which is, for example, IPS (in plain switching) mode or FFS (fringe field switching) mode that is modified from the IPS mode. In the meantime, in the embodiments, the vertical scanning direction is set in a direction traveling from the upper side to the lower side in FIG. 10; however, the vertical scanning direction may be set in a direction traveling from the lower side to the upper side, as described above.

In addition, in the above described embodiments, when the pixel capacitors 120 are regarded as a unit, writing polarity is inverted once in every period of one frame. This is merely for driving the pixel capacitors 120 with alternating current, so that the inversion cycle may be a cycle equal to or more than a period of two frame. Furthermore, the pixel capacitors 120 are set to a normally white mode; however, they may be set to a normally black mode in which it appears dark in a state of being applied with no voltage. In addition, color display may be performed with dots, each of which is constituted of three pixels, that is, R (red), G (green) and B (blue). Furthermore, another one color (for example, cyan (C)) may be added, and each of the dots may be constituted of these four color pixels to thereby improve a degree of color reproducibility.

In the above description, the reference of writing polarity uses the voltage LCcom applied to the common electrode 108; however, this is the case when the TFT 116 in each pixel 110 ideally functions as a switch. Actually, because of the parasitic capacitance between the gate and drain of the TFT 116, a phenomenon (termed as push down, push through, or field through) that the electric potential of the drain (pixel electrode 118) decreases when the TFT 116 shifts from an on state to an off state. In order to prevent degradation of the liquid crystal, the pixel capacitors 120 should be driven with alternating current; however, when alternating current driving is performed using the voltage LCcom applied to the common electrode 108 as the reference of writing polarity, because of push down, the effective voltage value of the pixel capacitor 120 in negative polarity writing is slightly higher than the effective value in positive polarity writing (when the TFT 116 is of an n-channel type). Thus, actually, the reference voltage of writing polarity and the voltage LCcom of the common electrode 108 may be independently provided, and, specifically, the reference voltage of writing polarity may be set higher to be offset from the voltage LCcom so as to cancel the influence of push down. Furthermore, each of the storage capacitors 130 is insulated in terms of direct current, so that it is only necessary that only a difference in electric potential applied to the first power supply line 165 and the second power supply line 166 establishes the above relationship, and, for example, a difference in electric potential with the voltage LCcom may be any voltage.

### Electronic Apparatus

Next, an electronic apparatus that includes the electro-optical device 10 according to the above described embodiments as a display device will be described. FIG. 31 is a view that shows the configuration of a cellular phone 1200 that uses the electro-optical device 10 according to the embodiments. As shown in the drawing, the cellular phone 1200 includes a plurality of operation buttons 1202, an earpiece 1204, a mouthpiece 1206, and the above described electro-optical device 10. Note that the components of a portion that corresponds to the display area 100 in the electro-optical device 10 do not externally appear.

Note that the electronic apparatuses to which the electro-optical device 10 may be applied include, in addition to the cellular phone shown in FIG. 31, a digital still camera, a notebook personal computer, a liquid crystal television, a view finder type (or direct view type) video camera, a car navigation system, a pager, an electronic personal organizer, an electronic calculator, a word processor, a workstation, a video telephone, a POS terminal, and devices provided with a touch panel. Then, needless to say, the above described electro-optical device 10 may be applied as a display device of these various electronic apparatuses.

The entire disclosure of Japanese Patent Application Nos. 2007-133792, filed May 21, 2007 and 2007-134034, May 21, 2007 are expressly incorporated by reference herein.

What is claimed is:

1. A driving circuit of an electro-optical device that includes a plurality of scanning lines, a plurality of data lines, a plurality of capacitor lines, and pixels, wherein the plurality of capacitor lines are respectively provided in correspondence with the plurality of scanning lines, wherein the pixels are provided at positions corresponding to intersections of the plurality of scanning lines and the plurality of data lines, wherein each of the pixels includes a pixel switching element, a pixel capacitor and a storage capacitor, wherein the pixel switching element is connected to a corresponding one of the data lines, a corresponding one of the scanning lines and a pixel electrode, wherein, when the connected corresponding one of the scanning lines is selected, the pixel electrode enters a conductive state with the corresponding one of the data lines, wherein the pixel capacitor is connected between the pixel electrode and a common electrode, wherein the storage capacitor is connected between the pixel electrode and a corresponding one of the capacitor lines, provided in correspondence with the corresponding one of the scanning lines, the driving circuit comprising:
a scanning line driving circuit that selects the scanning lines in a predetermined order;
a capacitor line driving circuit that, for the capacitor line provided in correspondence with one of the scanning lines, selects a first power supply line when the one of the scanning lines is selected and selects a second power supply line since a scanning line, which is spaced predetermined lines away from the one of the scanning lines and selected after the one of the scanning lines, is selected until the one of the scanning lines is selected again to thereby apply a voltage of the selected one of the power supply lines to the capacitor line, while the capacitor line driving circuit applies the voltage of the second power supply line to all the capacitor lines in a period during which all the scanning lines are not selected; and
a data line driving circuit that supplies the pixels corresponding to the selected one of the scanning lines with data signals corresponding to gray scales of the pixels through the respective data lines.

2. The driving circuit of the electro-optical device according to claim 1, wherein
the electro-optical device is configured to be selectable between a full-screen display mode in which a full screen is set as a display area and a partial display mode in which part of area in the full screen is set as a display area and the other area is set as a non-display area, and wherein
the capacitor line driving circuit, in the partial display mode, applies the voltage of the second power supply line to all the capacitor lines in a period during which all the scanning lines are not selected.

3. The driving circuit of the electro-optical device according to claim 1, wherein
the capacitor line driving circuit includes first to fifth transistors in correspondence with each of the capacitor lines, wherein
the first transistor corresponding to one of the capacitor lines has a gate electrode connected to a scanning line that is spaced predetermined lines away from the scanning line corresponding to the one of the capacitor lines and a source electrode connected to an on voltage supply line that supplies an on voltage to make the fourth transistor enter an on state, wherein
the second transistor has a gate electrode connected to the scanning line corresponding to the one of the capacitor lines and a source electrode connected to an off voltage supply line that supplies an off voltage to make the fourth transistor enter an off state, wherein
the third transistor has a gate electrode connected to the scanning line corresponding to the one of the capacitor lines and a source electrode connected to the first power supply line, wherein
the fourth transistor has a gate electrode connected commonly to both a drain electrode of the first transistor and a drain electrode of the second transistor and a source electrode connected to the second power supply line, wherein
the fifth transistor has a gate electrode connected to an on/off voltage supply line that supplies an on voltage or an off voltage to make the fifth transistor itself enter an on state or an off state and a source electrode connected to the second power supply line, wherein
a drain electrode of the third transistor, a drain electrode of the fourth transistor and a drain electrode of the fifth transistor are connected to the one of the capacitor lines, and wherein
a voltage of the on/off voltage supply line is controlled to be applied with the on voltage in a period during which all the scanning lines are not selected.

4. The driving circuit of the electro-optical device according to claim 1, wherein the voltage of the first power supply line and the voltage of the second power supply line are set so that, when a scanning line, which is spaced predetermined lines away from the scanning line corresponding to one of the capacitor lines, is selected, a voltage of the one of the capacitor lines varies.

5. The driving circuit of the electro-optical device according to claim 4, wherein
the voltage of the first power supply line is alternately switched at predetermined cycles between different two voltages, and wherein
the voltage of the second power supply line is constant.

6. The driving circuit of the electro-optical device according to claim 1, further comprising:
a correction circuit that, when the one of the scanning lines is selected, supplies the first power supply line with a voltage signal by which a detection voltage of the capacitor line corresponding to the one of the scanning lines becomes a target voltage.

7. An electro-optical device comprising:
a plurality of scanning lines;
a plurality of data lines;
a plurality of capacitor lines that are respectively provided in correspondence with the plurality of scanning lines;
pixels that are provided at positions corresponding to intersections of the plurality of scanning lines and the plurality of data lines, wherein each of the pixels includes a pixel switching element, a pixel capacitor and a storage capacitor, wherein the pixel switching element is connected to a corresponding one of the data lines, a corresponding one of the scanning lines and a pixel electrode, wherein, when the connected corresponding one of the scanning lines is selected, the pixel electrode enters a conductive state with the corresponding one of the data lines, wherein the pixel capacitor is connected between the pixel electrode and a common electrode, wherein the storage capacitor is connected between the pixel electrode and a corresponding one of the capacitor lines, provided in correspondence with the corresponding one of the scanning lines;
a scanning line driving circuit that selects the scanning lines in a predetermined order;
a capacitor line driving circuit, for the capacitor line provided in correspondence with one of the scanning lines, selects a first power supply line when the one of the scanning lines is selected and selects a second power supply line since a scanning line, which is spaced predetermined lines away from the one of the scanning lines and selected after the one of the scanning lines, is selected until the one of the scanning lines is selected again to thereby apply a voltage of the selected one of the power supply lines to the capacitor line, while the capacitor line driving circuit applies the voltage of the second power supply line to all the capacitor lines in a period during which all the scanning lines are not selected; and
a data line driving circuit that supplies the pixels corresponding to the selected one of the scanning lines with data signals corresponding to gray scales of the pixels through the respective data lines.

8. A driving circuit of an electro-optical device that includes a plurality of rows of scanning lines, a plurality of columns of data lines, capacitor lines, and pixels, wherein the capacitor lines are respectively provided in correspondence with the plurality of rows of scanning lines, wherein the pixels are provided at positions corresponding to intersections of the plurality of rows of scanning lines and the plurality of columns of data lines, wherein each of the pixels includes a pixel switching element, a pixel capacitor, and a storage capacitor, wherein one terminal of the pixel switching element is connected to a corresponding one of the data lines and, when a corresponding one of the scanning lines is selected, the pixel switching element enters a conductive state between the one terminal and the other terminal, wherein one terminal of the pixel capacitor is connected to the other terminal of the pixel switching element, and the other terminal of the pixel capacitor is connected to a common electrode, wherein the storage capacitor is connected between the one terminal of the pixel capacitor and the capacitor line corresponding to the corresponding one of the scanning lines, the driving circuit comprising:
a scanning line driving circuit that selects the scanning lines in a predetermined order;
a capacitor line driving circuit that connects the capacitor line provided in correspondence with one of the scanning lines to a first power supply line when the one of the scanning lines is selected, and that continues to connect the capacitor line to a second power supply line after the selection is completed; and
a data line driving circuit that supplies the pixels corresponding to the selected one of the scanning lines with data signals corresponding to gray scales of the pixels through the respective data lines, wherein
a voltage of the first power supply line, when the one of the scanning lines is selected, is set to be different from a voltage of the second power supply line.

9. The driving circuit of the electro-optical device according to claim 8, wherein
the voltage of the first power supply line is alternately switched at predetermined intervals between two different voltages, and wherein
the voltage of the second power supply line is constant.

10. The driving circuit of the electro-optical device according to claim 9, wherein the voltage of the second power supply line is set to an intermediate value between the two voltages of the first power supply line.

11. The driving circuit of the electro-optical device according to claim 8, wherein
the capacitor line driving circuit includes a first transistor, a second transistor, a third transistor and a fourth transistor in correspondence with each of the plurality of rows of capacitor lines, wherein
the first transistor corresponding to one of the capacitor lines has a gate electrode connected to a gate control line and a source electrode connected to an on voltage supply line that supplies an on voltage to make the fourth transistor enter an on state, wherein
the second transistor has a gate electrode connected to the scanning line corresponding to the one of the capacitor lines and a source electrode connected to an off voltage supply line that supplies an off voltage to make the fourth transistor enter an off state, wherein
the third transistor has a gate electrode connected to the scanning line corresponding to the one of the capacitor lines and a source electrode connected to the first power supply line, wherein
the fourth transistor has a gate electrode connected commonly to both a drain electrode of the first transistor and a drain electrode of the second transistor and a source electrode connected to the second power supply line, and wherein
a drain electrode of the third transistor and a drain electrode of the fourth transistor are connected to the one of the capacitor lines.

12. The driving circuit of the electro-optical device according to claim 11, wherein
the driving circuit includes a plurality of sets of the first transistor, the second transistor and the fourth transistor in correspondence with one of the capacitor lines, and wherein
the fourth transistor that connects the one of the capacitor lines to the second power supply line is switched among the plurality of sets in a predetermined order.

13. The driving circuit of the electro-optical device according to claim 11, wherein
the capacitor line driving circuit further includes a fifth transistor in correspondence with each of the plurality of rows of capacitor lines, and wherein
the fifth transistor corresponding to one of the capacitor lines has a gate electrode connected to a scanning line that is selected next with respect to the scanning line corresponding to the one of the capacitor lines, a source electrode connected to the on voltage supply line and a drain electrode connected to both a drain electrode of the first transistor and a drain electrode of the second transistor.

14. The driving circuit of the electro-optical device according to claim 11, further comprising:
an operational amplifier; and
a sixth transistor that is provided in correspondence with each of the plurality of rows of capacitor lines, wherein
the sixth transistor corresponding to one of the capacitor lines has a gate electrode connected to the scanning line corresponding to the one of the capacitor lines, a source electrode connected to the one of the capacitor lines and a drain electrode connected to a detection line, and wherein
the operational amplifier controls the voltage of the first power supply line so that a voltage of the detection line, when the one of the scanning lines is selected, becomes a target voltage.

15. An electro-optical device comprising:
a plurality of rows of scanning lines;
a plurality of columns of data lines;
capacitor lines that are respectively provided in correspondence with the plurality of rows of scanning lines; and
pixels that are provided at positions corresponding to intersections of the plurality of rows of scanning lines and the plurality of columns of data lines, wherein each of the pixels includes a pixel switching element, a pixel capacitor, and a storage capacitor, wherein one terminal of the pixel switching element is connected to a corresponding one of the data lines and, when a corresponding one of the scanning lines is selected, the pixel switching element enters a conductive state between the one terminal and the other terminal, wherein one terminal of the pixel capacitor is connected to the other terminal of the pixel switching element, and the other terminal of the pixel capacitor is connected to a common electrode, wherein the storage capacitor is connected between the one terminal of the pixel capacitor and the capacitor line corresponding to the corresponding one of the scanning lines;
a scanning line driving circuit that selects the scanning lines in a predetermined order;
a capacitor line driving circuit that connects the capacitor line provided in correspondence with one of the scanning lines to a first power supply line when the one of the scanning lines is selected, and that continues to connect the capacitor line to a second power supply line after the selection is completed; and
a data line driving circuit that supplies the pixels corresponding to the selected one of the scanning lines with data signals corresponding to gray scales of the pixels through the respective data lines, wherein
a voltage of the first power supply line, when the one of the scanning lines is selected, is set to be different from a voltage of the second power supply line.

16. An electronic apparatus comprising the electro-optical device according to claim 7.
